(19) United States
(12) Patent Application Publication
(10) Pub. No.: US 2001/0041665 A1
(43) Pub. Date: Nov. 15, 2001

(54) Pathogen-reducing systems, compositions, articles and methods employing ozone

(76) Inventors: John Cort Severns, West Chester, OH (US); Frederick Anthony Hartman, Cincinnati, OH (US); Christiaan Arthur Jacques Kamiel Thoen, West Chester, OH (US); Michael Charles Frazee, Cincinnati, OH (US)

Correspondence Address: THE PROCTER & GAMBLE COMPANY, PATENT DIVISION, IVORYDALE TECHNICAL CENTER - BOX 492, 5299 SPRING GROVE AVENUE, CINCINNATI, OH, 45217, US

(21) Appl. No.: 09/758,681

(22) Filed: Jan. 11, 2001

Related U.S. Application Data
(60) Provisional application No. 60/176,362, filed on Jan. 14, 2000.

(51) Int. Cl. C11D 1/00

(52) U.S. Cl. 510/218; 510/505

(57) ABSTRACT

The present invention relates to pathogen-reducing systems and methods employing ozone and compositions and articles useful therein. More particularly, the present invention relates to pathogen-reducing systems and methods useful in pathogen-reducing pathogen containing substrates/articles, such as sponges, wash cloths, scouring pads (i.e., plastic, metallic), utensils, dishes, cookware, pots, pans, skillets, baby bottles, baby nipples, glassware, dentures, brushes, gloves, reusable wipes, and the like wherein the substrate/article is treated with an ozone-enhancing composition and subjected with ozone in a closed environment, such that the ozone-enhancing composition and ozone are in contact with the substrate/article to be treated contemporaneously.

### CROSS REFERENCE TO RELATED APPLICATIONS

This application claims priority under 37 U.S.C. §119(e) to U. S. Provisional Application Serial No. 60/176,362, filed Jan. 14, 2000 (Attorney Docket No. 7920P).

### FIELD OF THE INVENTION

The present invention relates to pathogen-reducing systems and methods employing ozone and compositions and articles useful therein. More particularly, the present invention relates to pathogen-reducing systems and methods useful in pathogen-reducing pathogen containing substrates/articles, such as sponges, wash cloths, scouring pads (i.e., plastic, metallic), utensils, dishes, cookware, pots, pans, skillets, baby bottles, baby nipples, glassware, dentures, brushes, gloves, reusable wipes, and the like wherein the substrate/article is treated with an ozone-enhancing composition and subjected with ozone in a closed environment, such that the ozone-enhancing composition and ozone are in contact with the substrate/article to be treated contemporaneously.

### BACKGROUND OF THE INVENTION

Consumers are very conscientious about cleanliness and/or sanitization, especially when it comes to dishes, utensils, tableware, cookware, and cleaning articles, such as sponges, wash cloths, etc. that are typically found and/or used in kitchens and bathrooms at home and away from home, such as in restaurants. Accordingly, there is a need for a pathogen-reducing system and method that sanitizes such cleaning articles, such as sponges and wash cloths.

Ozone has been recognized in the art as being a sanitizer. The use of ozone and/or ozonated water to clean, deodorize and/or sanitize articles, objects and/or aqueous systems is known in the art. See for example: DE 29610335, U.S. Pat. No. 5,460,702, U.S. Pat. No. 5,603,972, EP 722 741, DE 4426647, JP 06296666, U.S. Pat. No. 5,858,435, JP 05163376, WO 97/20097, JP 08117708, WO 94/11486, EP 389 753, U.S. Pat. No. 5,776,351, JP 08176597, and Research Disclosure No. 398035.

However, none of these references teach, suggest or disclose treating an substrate/article in need of treatment with an ozone-enhancing composition and ozone, wherein the ozone-enhancing composition and ozone (in its gaseous form) are discrete from one another (i.e., not mixed, not ozonated water or some other ozonated solution), in a closed environment such that the ozone-enhancing composition and ozone are in contact with the substrate/article to be treated at the same time. Nor do any of these references teach a composition or system that kills or renders inactive pathogens better than ozone alone.

Accordingly, there is a need for pathogen-reducing systems and methods that employ ozone that kill or render inactive pathogens better than ozone alone; ozone-enhancing compositions and articles that are useful in such pathogen-reducing systems and methods; and pathogen-reducing systems and methods that are suitable for use in residential as well as commercial environments.

### SUMMARY OF THE INVENTION

The present invention fulfills the needs identified above by providing pathogen-reducing systems and methods that employ ozone and an ozone-enhancing composition and/or article of manufacture. Preferably, the systems, methods, compositions and articles of manufacture of the present invention are used by consumers in relatively small, confined areas, such as in their homes, restaurants, or other buildings or structures that humans visit. Therefore, preferably the systems and methods of the present invention occur in “sealed” systems to avoid any direct or indirect contact by consumers to ozone.

In accordance with one aspect of the present invention, a pathogen-reducing system comprising ozone wherein the pathogen-reducing system kills and/or renders inactive pathogens better than ozone alone kills and/or renders inactive the pathogens is provided by the present invention.

In accordance with another aspect of the present invention, a method for reducing pathogens on and/or in a pathogen-containing substrate/article comprising contacting the substrate/article with a pathogen-reducing system comprising ozone such that the pathogen-reducing system kills and/or renders inactive the pathogen better than ozone alone kills and/or renders inactive the pathogen is provided by the present invention.

In accordance with yet another aspect of the present invention, a pathogen-reduced substrate/article is provided as a result of the methods of the present invention.

In accordance with still yet another aspect of the present invention, a pathogen-reducing composition comprising an ozone-enhancing agent such that when the pathogen-reducing composition comes into contact with pathogens in the presence of ozone, the combination of the pathogen-reducing composition and ozone kills and/or renders inactive the pathogens better than ozone alone kills and/or renders inactive the pathogens is provided by the present invention.

In accordance with even still yet another aspect of the present invention, a product comprising a pathogen-reducing system and/or pathogen-reducing composition of the present invention, the product further including instructions for using the pathogen-reducing system and/or pathogen-reducing composition to kill and/or render inactive pathogens on and/or in a pathogen-containing substrate/article.

Accordingly, the present invention provides a pathogen-reducing system, method, and composition that utilize ozone, but kill and/or render inactive pathogens better than ozone alone, contained in and/or on a pathogen-containing substrate/article; and a pathogen-reduced substrate/article as a result of the methods of the present invention.

These and other objects, features and advantages will be clear from the following detailed description, examples and appended claims.

All percentages, ratios and proportions herein are on a weight basis based on a neat product unless otherwise indicated. All documents cited herein are hereby incorporated by reference.

### DETAILED DESCRIPTION OF THE INVENTION

### Definitions

“Kill”—“Kill” as used herein means to destroy, extinguish, do away with, remove pathogens. “Kill” is not intended to have the specific meaning known to microbiologists; namely, to “kill 10³ bugs”, and as associated with EPA's definition of “kill” under FIFRA. However, “kill” as used herein is broad enough to encompass the more specific microbiologists' definition of “kill”.

“Render Inactive”—“Render Inactive” as used herein means to immobilize, halt and/or stop the pathogens and/or to cause the pathogens to become dormant, idle, inert and/or non-toxic.

“Kills and/or Renders Inactive Pathogens Better than Ozone Alone”—“Kills and/or Renders Inactive Pathogens Better than Ozone Alone” as used herein means that it (system, method, composition plus ozone) kills and/or renders inactive more pathogens, kills and/or renders inactive a wider range of pathogens and/or kills and/or renders inactive pathogens at a faster rate.

“System”—“System” as used herein means a complex unity formed of many often, but not always, diverse parts (i.e., materials, compositions, devices, appliances, procedures, methods, conditions, etc.) subject to a common plan or serving a common purpose.

### Pathogen-reducing System

A pathogen-reducing system comprising ozone wherein the pathogen-reducing system kills and/or renders inactive pathogens better than ozone alone kills and/or renders inactive the pathogens is provided by the present invention.

Preferably, the ozone is introduced into the system as a gas, preferably from an ozone generator.

The pathogens in the system are preferably in contact with a substrate/article (a pathogen-containing substrate/article).

Preferably, the system preferably further comprises a housing in which the ozone is contained, and preferably further comprises an ozone-enhancing agent, more preferably a cleaning/detergent ingredient, even more preferably a surfactant, most preferably, a light-duty liquid detergent composition.

An additional embodiment of the present invention is a pathogen-reducing system comprising:

a) ozone in a gaseous form; and

b) a substrate comprising a pathogen and an ozone-enhancing agent;

wherein the pathogen-reducing system kills and/or renders inactive the pathogen better than ozone alone kills and/or renders inactive the pathogens.

A further embodiment of the present invention is a pathogen-reducing system comprising:

a) ozone in a gaseous form;

b) an ozone-enhancing agent; and

c) a substrate comprising a pathogen;

wherein the ozone and the ozone-enhancing agent are distinct from one another and the substrate comes into contact with b) then a) or a) then b), preferably b) then a).

Still a further embodiment of the present invention is a pathogen-reducing system comprising:

a) ozone in a gaseous form; and

b) a substrate comprising two or more genera of pathogens and an ozone-enhancing agent;

wherein the pathogen-reducing system kills and/or renders inactive at least one of the two or more genera of pathogens better than ozone alone kills and/or renders inactive the at least one of the two or more genera of pathogens.

Yet another embodiment of the present invention is a pathogen-reducing system comprising:

a) ozone in a gaseous form; and

b) a substrate comprising one or more pathogens selected from the group consisting of: Escherichia coli, Salmonella choleraesius, Listeria monocytogenes and mixtures thereof; and an ozone-enhancing agent;

wherein the pathogen-reducing system kills and/or renders inactive at least one of the one or more pathogens better than ozone alone kills and/or renders inactive the at least one of the one or more pathogens.

### A. Ozone

For reference, Kirk-Othmer Encyclopedia of Chemical Technology 4^{th} Ed. (1996) discusses ozone and its properties.

### 1. Point of Use Technology/Ozone Generator

As a result of ozone's very short lifetime, a means of generating/producing ozone at the point of use is essential for the methods of the present invention. Accordingly, an “ozone generator”is essential for the methods of the present invention to ensure that ozone is generated/produced at the point of use of the methods, systems, compositions, etc. of the present invention.

Ozone generators are well known in the art. There are two general classes of ozone generators. The first class is called corona discharge generators. The second class is called UV lamp generators. Either class of ozone generator is suitable for the methods and systems of the present invention. The ozone generators exists in various sizes, but the basic principles of ozone generators are not size dependent.

Various embodiments of ozone generators are described in the art. Representative nonlimiting examples of ozone generators are described in the following references: U.S. Pat. Nos. 5,100,521, 5,087,426, 5,866,082, 5,770,033, 5,460,705, 5,762,886, 5,756,054, 5,751,007, 5,733,512, 5,855,856, 5,868,999, 5,702,673, 5,759,497, 5,578,280, 5,525,310, 5,503,809, 5,587,131, 5,093,087, 4,892,713 and 5,666,640; European Patent Nos. 397 145, 888 135, 738 684, 679 608 and 837 032; PCT Publication Nos. WO 97/34643 and WO 89/11909; Japanese Patent Nos. 10075993, 07328661, 07328619, 07328617, 60016804, 07187611, 07157301, 03054101, 02296704 and 71000801; DE 2522775, DE 3941897, GB 2276521 and SU 941278. Representative companies known in the ozone generator area are Mitsubishi Denki KK and Mitsubishi Electric Corp.

### 2. Exposure Conditions

The ability of a material such as ozone and/or ozone in the presence of an ozone-enhancing agent to kill and/or render inactive pathogens is determined by concentration of such material in contact with a substrate and time such material remains in contact with the substrate.

The lower the concentration of ozone, the longer the exposure time needed to kill and/or render inactive a specific amount of pathogens. The higher the concentration of ozone, the shorter the exposure time needed to kill and/or render inactive the same specific amount of pathogens. For example, a 1 ppm concentration of ozone exposed to a substrate for 10 hours kills and/or renders inactive X amount of pathogens, whereas, a 10 ppm concentration of ozone exposed to the same substrate kills and/or renders inactive X amount of pathogens in 1 hour.

### a. Level (Concentration) of Ozone

The level of ozone used in the systems and methods of the present invention is preferably a sufficient level to kill and/or render inactive the pathogens present on the substrate to be sanitized (i.e., to have the pathogens present on the substrate reduced, killed and/or rendered inactive). Too high a level of ozone can result in degradation of substrate contacted by ozone.

The preferred level of ozone in accordance with the present invention is at least 0.1 ppm, more preferably at least 1 ppm, even more preferably at least 10 ppm, most preferably at least 100 ppm. As for the maximum level of ozone, as discussed above, the level of ozone can be as high as desired so long as the ozone does not degrade the substrate, preferably to about 1000 ppm, more preferably to about 500 ppm.

### b. Time Substrate is Exposed to Ozone

In accordance with the present invention, the substrates are exposed to ozone for a sufficient amount of time such that the desired amount of pathogens are killed and/or rendered inactive. Preferably, the substrates are exposed to ozone for at least 5 minutes, more preferably at least 10 minutes, still more preferably at least 1 hour, even more preferably at least 3 to 4 hours (“the period between uses of the substrate”) and most preferably about 8 to 12 hours (“overnight”).

In use, a combination of exposure times during a 24 hour period may be most beneficial and desirable to a consumer.

### B. Ozone-enhancing Agent

It has been surprisingly found that some materials, when used in the presence of ozone, enhance the ability of ozone to kill and/or render inactive pathogens better than ozone alone (in the absence of such materials). For purposes of the present invention, these materials are called “ozone-enhancing agents”.

Without being bound by theory, it is believed that the ozone-enhancing agents enable ozone to distribute itself from gas phase throughout the substrate (article), especially porous and/or amorphous substrates, more effectively than ozone in the absence of the ozone-enhancing agent. Also, without being bound by theory, it is believed that the ozone-enhancing agent increases the ability of ozone to contact the pathogens.

Preferably, the ozone-enhancing agent of the present invention is delivered to or is present on the substrate in a fluid or liquid form, more preferably in a suspension or solution of water.

The ozone-enhancing agent preferably comprises water and one or more other detergent ingredients, preferably a surfactant and/or one or more other detergent ingredients, such as perfumes.

Surfactants—A wide range of surfactants can be used in the compositions of the present invention.

Surfactants included in the fully-formulated compositions afforded by the present invention comprise at least 0.01%, preferably at least about 0.1%, more preferably at least about 0.5%, even more preferably at least about 1%, most preferably at least about 3% to about 80%, more preferably to about 60%, most preferably to about 50% by weight of treating composition depending upon the particular surfactants used and the desired effects to be achieved.

The surfactant can be nonionic, anionic, amphoteric, amphophilic, zwitterionic, cationic, semi-polar nonionic, and mixtures thereof, nonlimiting examples of which are disclosed in U.S. Pat. Nos. 5,707,950 and 5,576,282. A typical listing of anionic, nonionic, amphoteric and zwitterionic classes, and species of these surfactants, is given in U.S. Pat. No. 3,664,961 issued to Norris on May 23, 1972. Preferred treating compositions comprise nonionic surfactants and/or mixtures of nonionic surfactants with other surfactants, especially anionic surfactants.

Nonlimiting examples of surfactants useful herein include the conventional C₈-C₁₈ alkyl ethoxylates (“AE”), with EO about 1-22, including the so-called narrow peaked alkyl ethoxylates and C₆-C₁₂ alkyl phenol alkoxylates (especially ethoxylates and mixed ethoxy/propoxy), alkyl dialkyl amine oxide, alkanoyl glucose amide, C₁₁-C₁₈ alkyl benzene sulfonates and primary, secondary and random alkyl sulfates, the C₁₀-C₁₈ alkyl alkoxy sulfates, the C₁₀-C₁₈ alkyl polyglycosides and their corresponding sulfated polyglycosides, C₁₂-C₁₈ alpha-sulfonated fatty acid esters, C₁₂-C₁₈ alkyl and alkyl phenol alkoxylates (especially ethoxylates and mixed ethoxy/propoxy), C₁₂-C₁₈ betaines and sulfobetaines (“sultaines”), C₁₀-C₁₈ amine oxides, and the like. Other conventional useful surfactants are listed in standard texts.

### i. Nonionic Surfactant

Suitable nonionic surfactants are generally disclosed in U.S. Pat. No. 3,929,678, Laughlin et al., issued Dec. 30, 1975, and U.S. Pat. No. 4,285,841, Barrat et al, issued Aug. 25, 1981. Exemplary, non-limiting classes of useful nonionic surfactants include: C₈-C₁₈ alkyl ethoxylates (“AE”), with EO about 1-22, including the so-called narrow peaked alkyl ethoxylates and C₆-C₁₂ alkyl phenol alkoxylates (especially ethoxylates and mixed ethoxy/propoxy), alkyl dialkyl amine oxide, alkanoyl glucose amide, and mixtures thereof.

It is well known that the ethoxylated alcohols often form viscous phases when combined with water at certain concentrations. This will appreciated by one skilled in the art such that extremely viscous solutions can be avoided either in the making of the product or in the dissolution of the product during use of the product. This can be done through a variety of means including but not limited to the use of solvents, control of ionic strength, surfactant selection, use and selection of cosurfactants, surfactant to water ratio etc. Alternatively, one skilled in the art may use and control this property so as to give a gel or viscous liquid or paste as may be desired.

If nonionic surfactants are used, the compositions of the present invention will preferably contain from about 1% to about 80%, more preferably from about 1% to about 60%, most preferably from about 1% to about 50% by weight of nonionic surfactant.

Preferred nonionic surfactants include, but are not limited to, the ethoxylated alcohols and ethoxylated alkyl phenols of the formula R(OC₂H₄)ₙOH, wherein R is selected from the group consisting of aliphatic hydrocarbon radicals containing from about 8 to about 15 carbon atoms and alkyl phenyl radicals in which the alkyl groups contain from about 8 to about 12 carbon atoms, and the average value of n is from about 5 to about 15. These surfactants are more fully described in U.S. Pat. No. 4,284,532, Leikhim et al, issued Aug. 18, 1981. Particularly preferred are ethoxylated alcohols having an average of from about 9 to abut 15 carbon atoms in the alcohol and an average degree of ethoxylation of from about 5 to about 15 moles of ethylene oxide per mole of alcohol.

Other nonionic surfactants for use herein include:

The polyethylene, polypropylene, and polybutylene oxide condensates of alkyl phenols. In general, the polyethylene oxide condensates are preferred. These compounds include the condensation products of alkyl phenols having an alkyl group containing from about 6 to about 12 carbon atoms in either a straight chain or branched chain configuration with the alkylene oxide. In a preferred embodiment, the ethylene oxide is present in an amount equal to from about 5 to about 25 moles of ethylene oxide per mole of alkyl phenol. Commercially available nonionic surfactants of this type include Igepal® CO-630, marketed by the GAF Corporation; and Triton® X-45, X-114, X-100, and X-102, all marketed by the Rohm & Haas Company. These compounds are commonly referred to as alkyl phenol alkoxylates, (e.g., alkyl phenol ethoxylates).

The condensation products of aliphatic alcohols with from about 1 to about 25 moles of ethylene oxide. The alkyl chain of the aliphatic alcohol can either be straight or branched, primary or secondary, and generally contains from about 8 to about 22 carbon atoms. Particularly preferred are the condensation products of alcohols having an alkyl group containing from about 10 to about 20 carbon atoms with from about 2 to about 18 moles of ethylene oxide per mole of alcohol. Examples of commercially available nonionic surfactants of this type include Tergitol® 15-S-9 (the condensation product of C₁₁-C₁₅ linear secondary alcohol with 9 moles ethylene oxide), Tergitol® 24-L-6 NMW (the condensation product of C₁₂-C₁₄ primary alcohol with 6 moles ethylene oxide with a narrow molecular weight distribution), both marketed by Union Carbide Corporation; Neodol® 45-9 (the condensation product of C₁₄-C₁₅ linear alcohol with 9 moles of ethylene oxide), Neodol® 23-9 (the condensation product of C₁₂-C₁₃ linear alcohol with 9 moles of ethylene oxide); Neodol® 23-6.5 (the condensation product of C₁₂-C₁₃ linear alcohol with 6.5 moles of ethylene oxide), Neodol® 45-7 (the condensation product of C₁₄-C₁₅ linear alcohol with 7 moles of ethylene oxide), Neodol® 45-4 (the condensation product of C₁₄-C₁₅ linear alcohol with 4 moles of ethylene oxide), marketed by Shell Chemical Company, and Kyro® EOB (the condensation product of C₁₃-C₁₅ alcohol with 9 moles ethylene oxide), marketed by The Procter & Gamble Company. Other commercially available nonionic surfactants include Dobanol 91-8® marketed by Shell Chemical Co. and Genapol UD-080® marketed by Hoechst. This category of nonionic surfactant is referred to generally as “alkyl ethoxylates.” Especially preferred nonionic surfactants of this type are the C₉-C₁₅ primary alcohol ethoxylates containing 5-12 moles of ethylene oxide per mole of alcohol, particularly the C₉-C₁₂ primary alcohols containing 6-10 moles of ethylene oxide per mole of alcohol and the C₁₂-C₁₄ primary alcohols containing 6-12 moles of ethylene oxide per mole of alcohol.

The condensation products of ethylene oxide with a hydrophobic base formed by the condensation of propylene oxide with propylene glycol. The hydrophobic portion of these compounds preferably has a molecular weight of from about 1500 to about 1800 and exhibits water insolubility. The addition of polyoxyethylene moieties to this hydrophobic portion tends to increase the water solubility of the molecule as a whole, and the liquid character of the product is retained up to the point where the polyoxyethylene content is about 50% of the total weight of the condensation product, which corresponds to condensation with up to about 40 moles of ethylene oxide. Examples of compounds of this type include certain of the commercially-available Pluronic® surfactants, marketed by BASF.

The condensation products of ethylene oxide with the product resulting from the reaction of propylene oxide and ethylenediamine. The hydrophobic moiety of these products consists of the reaction product of ethylenediamine and excess propylene oxide, and generally has a molecular weight of from about 2500 to about 3000. This hydrophobic moiety is condensed with ethylene oxide to the extent that the condensation product contains from about 40% to about 80% by weight of polyoxyethylene and has a molecular weight of from about 5,000 to about 11,000. Particularly useful are condensates of ethylene oxide with a hydrophobic moiety to provide a surfactant having an average hydrophilic-lipophilic balance (HLB) in the range from 8 to 17, preferably from 8.5 to 13.5, more preferably from 8.5 to 11.5. The hydrophobic (lipophilic) moiety may be aliphatic or aromatic in nature and the length of the polyoxyethylene group which is condensed with any particular hydrophobic group can be readily adjusted to yield a water-soluble compound having the desired degree of balance between hydrophilic and hydrophobic elements. Examples of this type of nonionic surfactant include certain of the commercially available Tetronic® compounds, marketed by BASF.

Semi-polar nonionic surfactants are a special category of nonionic surfactants which include water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Semi-polar nonionic detergent surfactants include the amine oxide surfactants having the formula:

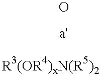

wherein R³ is an alkyl, hydroxyalkyl, or alkyl phenyl group or mixtures thereof containing from about 8 to about 22 carbon atoms; R⁴ is an alkylene or hydroxyalkylene group containing from about 2 to about 3 carbon atoms or mixtures thereof; x is from 0 to about 3; and each R⁵ is an alkyl or hydroxyalkyl group containing from about 1 to about 3 carbon atoms or a polyethylene oxide group containing from about 1 to about 3 ethylene oxide groups. The R⁵ groups can be attached to each other, e.g., through an oxygen or nitrogen atom, to form a ring structure.

These amine oxide surfactants in particular include C₁₀-C₁₈ alkyl dimethyl amine oxides and C₈-C₁₂ alkoxy ethyl dihydroxy ethyl amine oxides.

Alkylpolysaccharides disclosed in U.S. Pat. No. 4,565,647, Llenado, issued Jan. 21, 1986, having a hydrophobic group containing from about 6 to about 30 carbon atoms, preferably from about 10 to about 16 carbon atoms and a polysaccharide, e.g., a polyglycoside, hydrophilic group containing from about 1.3 to about 10, preferably from about 1.3 to about 3, most preferably from about 1.3 to about 2.7 saccharide units. Any reducing saccharide containing 5 or 6 carbon atoms can be used, e.g., glucose, galactose and galactosyl moieties can be substituted for the glucosyl moieties. (Optionally the hydrophobic group is attached at the 2-, 3-, 4-, etc. positions thus giving a glucose or galactose as opposed to a glucoside or galactoside.) The intersaccharide bonds can be, e.g., between the one position of the additional saccharide units and the 2-, 3-, 4-, and/or 6- positions on the preceding saccharide units.

Optionally, and less desirably, there can be a polyalkylene-oxide chain joining the hydrophobic moiety and the polysaccharide moiety. The preferred alkyleneoxide is ethylene oxide. Typical hydrophobic groups include alkyl groups, either saturated or unsaturated, branched or unbranched containing from about 8 to about 18, preferably from about 10 to about 16, carbon atoms. Preferably, the alkyl group is a straight chain saturated alkyl group. The alkyl group can contain up to about 3 hydroxy groups and/or the polyalkyleneoxide chain can contain up to about 10, preferably less than 5, alkyleneoxide moieties. Suitable alkyl polysaccharides are octyl, nonyl, decyl, undecyldodecyl, tridecyl, tetradecyl, pentadecyl, hexadecyl, heptadecyl, and octadecyl, di-, tri-, tetra-, penta-, and hexaglucosides, galactosides, lactosides, glucoses, fructosides, fructoses and/or galactoses. Suitable mixtures include coconut alkyl, di-, tri-, tetra-, and pentaglucosides and tallow alkyl tetra-, penta-, and hexa-glucosides.

The preferred alkylpolyglycosides have the formula:

R²O(CₙH₂ₙO)ₜ(glycosyl)ₓ

wherein R² is selected from the group consisting of alkyl, alkyl-phenyl, hydroxyalkyl, hydroxyalkylphenyl, and mixtures thereof in which the alkyl groups contain from about 10 to about 18, preferably from about 12 to about 14, carbon atoms; n is 2 or 3, preferably 2; t is from 0 to about 10, preferably 0; and x is from about 1.3 to about 10, preferably from about 1.3 to about 3, most preferably from about 1.3 to about 2.7. The glycosyl is preferably derived from glucose. To prepare these compounds, the alcohol or alkylpolyethoxy alcohol is formed first and then reacted with glucose, or a source of glucose, to form the glucoside (attachment at the 1-position). The additional glycosyl units can then be attached between their 1-position and the preceding glycosyl units 2-, 3-, 4- and/or 6-position, preferably predominantly the 2-position. Compounds of this type and their use in detergent are disclosed in EP-B 0 070 077, 0 075 996 and 0 094 118.

Fatty acid amide surfactants having the formula:

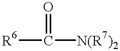

wherein R⁶ is an alkyl group containing from about 7 to about 21 (preferably from about 9 to about 17) carbon atoms and each R⁷ is selected from the group consisting of hydrogen, C₁-C₄ alkyl, C₁-C₄ hydroxyalkyl, and —(C²H₄O)ₓH where x varies from about 1 to about 3.

Preferred amides are C₈-C₂₀ ammonia amides, monoethanolamides, diethanolamides, and isopropanolamides.

These and other nonionic surfactants are well known in the art, being described in more detail in Kirk Othmer's Encyclopedia of Chemical Technology, 3rd Ed., Vol. 22, pp. 360-379, “Surfactants and Detersive Systems”, incorporated by reference herein.

### ii. Anionic Surfactant

Generally speaking, anionic surfactants useful herein are disclosed in U.S. Pat. No. 4,285,841, Barrat et al, issued Aug. 25, 1981, and in U.S. Pat. No. 3,919,678, Laughlin et al, issued Dec. 30, 1975, both incorporated herein by reference.

Anionic surfactants include, but are not limited to, linear alkylbenzene sulfonate, alpha olefin sulfonate, paraffin sulfonates, alkyl ester sulfonates, alkyl sulfates, alkyl alkoxy sulfate, alkyl sulfonates, alkyl alkoxy carboxylate, alkyl alkoxylated sulfates, sarcosinates, taurinates, and mixtures thereof More preferably, the anionic surfactants include, but are not limited to, C₁₁-C₁₈ alkyl benzene sulfonates (LAS) and primary, branched-chain and random C₁₀-C₂₀ alkyl sulfates (AS), the C₁₀-C₁₈ secondary (2,3) alkyl sulfates of the formula CH₃(CH₂)ₓ(CHOSO₃⁻M⁺) CH₃ and CH₃ (CH₂)_{y}(CHOSO₃⁻M) CH₂CH₃ where x and (y+1) are integers of at least about 7, preferably at least about 9, and M is a water-solubilizing cation, especially sodium, unsaturated sulfates such as oleyl sulfate, the C₁₀-C₁₈ alkyl alkoxy sulfates (“AEₓS”; especially EO 1-7 ethoxy sulfates), C₁₀-C₁₈ alkyl alkoxy carboxylates (especially the EO 1-11 ethoxycarboxylates), the C ₁ O-C 1₈ sulfated glycerol ethers, the C₁₀-C₁₈ sulfated alkyl polyglycosides, and C₁₂-C₁₈ alpha-sulfonated fatty acid esters.

Useful anionic surfactants include the water-soluble salts, particularly the alkali metal, ammonium and alkylolammonium (e.g., monoethanolammonium or triethanolammonium) salts, of organic sulfuric reaction products having in their molecular structure an alkyl group containing from about 10 to about 20 carbon atoms and a sulfonic acid or sulfuric acid ester group. (Included in the term “alkyl” is the alkyl portion of aryl groups.) Examples of this group of synthetic surfactants are the alkyl sulfates, especially those obtained by sulfating the higher alcohols (C₈-C₁₈ carbon atoms) such as those produced by reducing the glycerides of tallow or coconut oil. Especially valuable are linear straight chain alkylbenzene sulfonates in which the average number of carbon atoms in the alkyl group is from about 11 to 13, abbreviated as C₁₁-C₁₃LAS.

Other anionic surfactants herein are the water-soluble salts of alkyl phenol ethylene oxide ether sulfates containing from about 1 to about 4 units of ethylene oxide per molecule and from about 8 to about 12 carbon atoms in the alkyl group.

Other useful anionic surfactants herein include the water-soluble salts of esters of (x-sulfonated fatty acids containing from about 6 to 20 carbon atoms in the fatty acid group and from about 1 to 10 carbon atoms in the ester group; water-soluble salts of 2-acyloxy-alkane-1-sulfonic acids containing from about 2 to 9 carbon atoms in the acyl group and from about 9 to about 23 carbon atoms in the alkane moiety; water-soluble salts of olefin sulfonates containing from about 12 to 24 carbon atoms; and b-alkyloxy alkane sulfonates containing from about 1 to 3 carbon atoms in the alkyl group and from about 8 to 20 carbon atoms in the alkane moiety.

Examples of alkyl ester sulfonate surfactants comprise alkyl ester sulfonate surfactants of the structural formula:

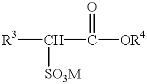

wherein R³ is a C₈-C₂₀ hydrocarbyl, preferably an alkyl, or combination thereof, R⁴ is a C₁-C₆ hydrocarbyl, preferably an alkyl, or combination thereof, and M is a cation which forms a water soluble salt with the alkyl ester sulfonate. Suitable salt-forming cations include metals such as sodium, potassium, and lithium, and substituted or unsubstituted ammonium cations, such as monoethanolamine, diethanolamine, and triethanolamine. Preferably, R³ is C₁₀-C₁₆ alkyl, and R⁴ is methyl, ethyl or isopropyl. Especially preferred are the methyl ester sulfonates wherein R³ is C₁₀-C₁₆ alkyl.

Other suitable anionic surfactants include the alkyl sulfate surfactants which are water soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation. Typically, alkyl chains of C₁₂-C₁₆ are preferred for lower wash temperatures (e.g. below about 50° C.) and C₁₆₋₁₈ alkyl chains are preferred for higher wash temperatures (e.g. above about 50° C.).

Other anionic surfactants useful for detersive purposes include salts of soap, C₈-C₂₂ primary of secondary alkanesulfonates, C₈-C₂₄ olefinsulfonates, sulfonated polycarboxylic acids prepared by sulfonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl glycerol sulfonates, fatty acyl glycerol sulfonates, fatty oleyl glycerol sulfates, alkyl phenol ethylene oxide ether sulfates, paraffin sulfonates, alkyl phosphates, isethionates such as the acyl isethionates, N-acyl taurates, alkyl succinamates and sulfosuccinates, monoesters of sulfosuccinates (especially saturated and unsaturated C₁₂-C₁₈ monoesters) and diesters of sulfosuccinates (especially saturated and unsaturated C₆-C₁₂ diesters), acyl sarcosinates, sulfates of alkylpolysaccharides such as the sulfates of alkylpolyglucoside (the nonionic nonsulfated compounds being described below), branched primary alkyl sulfates, and alkyl polyethoxy carboxylates such as those of the formula RO(CH₂CH₂O)ₖ—CH₂COO—M+wherein R is a C₈-C₂₂ alkyl, k is an integer from 1 to 10, and M is a soluble salt-forming cation. Resin acids and hydrogenated resin acids are also suitable, such as rosin, hydrogenated rosin, and resin acids and hydrogenated resin acids present in or derived from tall oil.

Further examples are described in copending provisional patent application of Chandrika Kasturi et al., entitled “Liquid Detergent Compositions Comprising Polymeric Suds Enhancers”, having P & G Case No. 6938P, serial no. 60/066,344 and filed on Nov. 21, 1997 and “Surface Active Agents and Detergents” (Vol. I and II by Schwartz, Perry and Berch). A variety of such surfactants are also generally disclosed in U.S. Pat. No. 3,929,678, issued Dec. 30, 1975 to Laughlin, et al. at Column 23, line 58 through Column 29, line 23 (herein incorporated by reference).

Preferred alkyl sulfate surfactants are the non-ethoxylated C₁₂₋₁₅ primary and secondary alkyl sulfates. Under cold water washing conditions, i.e., less than about 65° F. (18.3° C.), when alkyl sulfates are present, it is preferred that there be a mixture of such ethoxylated and non-ethoxylated alkyl sulfates.

Highly preferred anionic surfactants include alkyl alkoxylated sulfate surfactants hereof are water soluble salts or acids of the formula RO(A)ₘSO3M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between about 0.5 and about 6, more preferably between about 0.5 and about 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl, trimethyl-ammonium cations and quaternary ammonium cations such as tetramethyl-ammonium and dimethyl piperdinium cations and those derived from alkylamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)M), C₁₂-C₁₈ alkyl polyethoxylate (2.25) sulfate (C₁₂-C₁₈E(2.25)M), C₁₂-C₁₈ alkyl polyethoxylate (3.0) sulfate (C₁₂-C₁₈E(3.0)M), and C₁₂-C₁₈ alkyl polyethoxylate (4.0) sulfate (C₁₂-C₁₈E(4.0)M), wherein M is conveniently selected from sodium and potassium.

When included therein, the treating compositions of the present invention typically comprise from about 0.5%, preferably from about 3%, more preferably from about 5%, most preferably from about 10% to about 90%, preferably to about 50%, more preferably to about 20%, most preferably to about 10% by weight of such anionic surfactants.

### iii. Amine Oxide Surfactants

The compositions herein may also contain amine oxide surfactants of the formula:

R¹(EO)ₓ(PO)_{y}(BO)_{z}N(O)(CH₂R′)₂.qH₂O (I)

In general, it can be seen that the structure (I) provides one long-chain moiety R¹(EO)ₓ(PO)_{y}(BO)_{z} and two short chain moieties, CH₂R′. R′ is preferably selected from hydrogen, methyl and —CH₂OH. In general R¹ is a primary or branched hydrocarbyl moiety which can be saturated or unsaturated, preferably, R¹ is a primary alkyl moiety. When x+y+z=0, R¹ is a hydrocarbyl moiety having chain length of from about 8 to about 18. When x+y+z is different from 0, R¹ may be somewhat longer, having a chainlength in the range C₁₂-C₂₄. The general formula also encompasses amine oxides wherein x+y+z=0, R¹=C₈-C₁₈, R′ is H and q is 0-2, preferably 2. These amine oxides are illustrated by C₁₂₋₁₄ alkyldimethyl amine oxide, hexadecyl dimethylamine oxide, octadecylamine oxide and their hydrates, especially the dihydrates as disclosed in U.S. Pat. Nos. 5,075,501 and 5,071,594, incorporated herein by reference.

The invention may also encompass amine oxides wherein x+y+z is different from zero, specifically x+y+z is from about 1 to about 10, R¹ is a primary alkyl group containing 8 to about 24 carbons, preferably from about 12 to about 16 carbon atoms; in these embodiments y +z is preferably 0 and x is preferably from about 1 to about 6, more preferably from about 2 to about 4; EO represents ethyleneoxy; PO represents propyleneoxy; and BO represents butyleneoxy. Such amine oxides can be prepared by conventional synthetic methods, e.g., by the reaction of alkylethoxysulfates with dimethylamine followed by oxidation of the ethoxylated amine with hydrogen peroxide. Also suitable are amine oxides such as propyl amine oxides, represented by the formula:

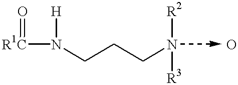

wherein R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10.

A further suitable species of amine oxide semi-polar surface active agents comprise compounds and mixtures of compounds having the formula:

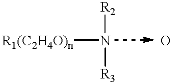

wherein R₁ is an alkyl, 2-hydroxyalkyl, 3-hydroxyalkyl, or 3-alkoxy-2-hydroxypropyl radical in which the alkyl and alkoxy, respectively, contain from about 8 to about 18 carbon atoms, R₂ and R₃ are each methyl, ethyl, propyl, isopropyl, 2-hydroxyethyl, 2-hydroxypropyl, or 3-hydroxypropyl and n is from 0 to about 10. Particularly preferred are amine oxides of the formula:

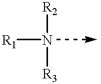

wherein R₁ is a C₁₀₋₁₄ alkyl and R₂ and R₃ are methyl or ethyl. Because they are low-foaming it may also be desirable to use long chain amine oxide surfactants which are more fully described in U.S. Pat. No. 4,316,824 (Pancheri), U.S. Pat. Nos. 5,075,501 and 5,071,594, incorporated herein by reference.

Highly preferred amine oxides herein are solids at ambient temperature, more preferably they have melting-points in the range 30° C. to 90° C. Amine oxides suitable for use herein are made commercially by a number of suppliers, including Akzo Chemie, Ethyl Corp., and Procter & Gamble. See McCutcheon's compilation and Kirk-Othmer review article for alternate amine oxide manufacturers. Preferred commercially available amine oxides are the solid, dihydrate ADMOX 16 and ADMOX 18, ADMOX 12 and especially ADMOX 14 from Ethyl Corp.

Preferred embodiments include dodecyldimethylamine oxide dihydrate, hexadecyldimethylamine oxide dihydrate, octadecyldimethylamine oxide dihydrate, hexadecyltris(ethyleneoxy)dimethyl-amine oxide, tetradecyldimethylamine oxide dihydrate, and mixtures thereof.

Whereas in certain of the preferred embodiments R′ is H, there is some latitude with respect to having R′ slightly larger than H. Specifically, the invention further encompasses embodiments wherein R′ is CH₂OH, such as hexadecylbis(2-hydroxyethyl)amine oxide, tallowbis(2-hydroxyethyl)amine oxide, stearylbis(2-hydroxyethyl)amine oxide and oleylbis(2- hydroxyethyl)amine oxide.

### iv. Cosurfactants

The treating compositions of the present invention may further comprise, especially when anionic surfactants are present, a cosurfactant selected from the group of primary or tertiary amines. Suitable primary amines for use herein include amines according to the formula:

R₁NH₂

wherein R₁ is a C₆-C₁₂, preferably C₆-C₁₀ alkyl chain, or R₄X(CH₂)ₙ, wherein X is —O——C(O)NH— or —NH—, R₄ is a C₆-C₁₂ alkyl chain n is between 1 to 5, preferably 3. R₁ alkyl chains may be straight or branched and may be interrupted with up to 12, preferably less than 5 ethylene oxide moieties; or

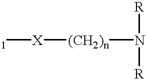

wherein R₁ is a C₆-C₁₂ alkyl group; n is from about 1 to 5, preferably 2 to about 4, more preferably 3. X is a bridging group which is selected from —NH—, —C(O)NH—, —C(O)O—, or —O— or X can be absent; and R₃ and R₄ are individually selected from H, C₁-C₄ alkyl, or (CH₂—CH₂—O(R₅)) wherein R₅ is H or methyl;

Preferred amines according to the formula herein above are n-alkyl amines. Suitable amines for use herein may be selected from 1-hexylamine, 1-octylamine, 1-decylamine and laurylamine. Other preferred primary amines include C8-C10oxypropylamine, octyloxypropylamine, 2-ethylhexyl-oxypropylamine, lauryl amido propylamine and amido propylamine. The most preferred amines for use in the compositions herein are 1-hexylamine, 1-octylamine, 1-decylamine, 1-dodecylamine. Especially desirable are n-dodecyldimethylamine and bishydroxyethylcoconutalkylamine and oleylamine 7 times ethoxylated, lauryl amido propylamine and cocoamido propylamine.

Preferred amines include the following:

R₁—(CH₂)₂—NH₂ (1)

R₁—O—(CH₂)₃—NH₂ (2)

R₁—C(O—NH—(CH₂)₃—N(CH₃)₂ (3)

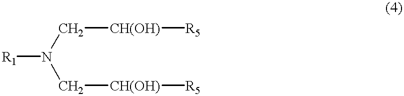

wherein R₁ is a C₆-C₁₂ alkyl group and R₅ is H or CH₃.

In a highly preferred embodiment, the amine is described by the formula:

R₁ —C(O)—NH—(CH₂)₃—N(CH₃)₂

wherein R₁ is C₈-C₁₂ alkyl.

Particularly preferred amines include those selected from the group consisting of octyl amine, hexyl amine, decyl amine, dodecyl amine, C₈-C₁₂ bis(hydroxyethyl)amine, C₈-C₁₂ bis(hydroxyisopropyl)amine, and C₈-C₁₂ amido-propyl dimethyl amine, and mixtures.

If utilized the detersive amines comprise from about 0.1% to about 10%, preferably from about 0.5% to about 5%, by weight of the composition.

### y. Quaternary Ammonium Surfactants

Suitable quaternary ammonium surfactants include, but are not limited to, quaternary ammonium surfactants having the formula:

[chemical structure]

wherein R₁ and R₂ are individually selected from the group consisting of C₁-C₄ alkyl, C₁-C₄ hydroxy alkyl, benzyl, and —(C₂H₄O)ₓH where x has a value from about 2 to about 5; X is an anion; and (1) R₃ and R₄ are each a C₆-C₁₄ alkyl or (2) R₃ is a C₆-C₁₈ alkyl, and R4 is selected from the group consisting of C₁-C₁₀ alkyl, C₁-C₁₀ hydroxy alkyl, benzyl, and —(C₂H₄O)ₓH where x has a value from 2 to 5.

Preferred quaternary ammonium surfactants are the chloride, bromide, and methylsulfate salts. Examples of preferred mono-long chain alkyl quaternary ammonium surfactants are those wherein R₁, R₂, and R₄ are each methyl and R₃ is a C₈-C₁₆ alkyl; or wherein R₃ is C₈-C₁₈ alkyl and R₁, R₂, and R₄ are selected from methyl and hydroxyalkyl moieties. Lauryl trimethyl ammonium chloride, myristyl trimethyl ammonium chloride, palmityl trimethyl ammonium chloride, coconut trimethylammonium chloride, coconut trimethylammonium methylsulfate, coconut dimethyl-monohydroxyethylammonium chloride, coconut dimethyl-monohydroxyethylammonium methylsulfate, steryl dimethyl-monohydroxy-ethylammonium chloride, steryl dimethylmonohydroxyethylammonium methylsulfate, di- C₁₂-C₁₄ alkyl dimethyl ammonium chloride, and mixtures thereof are particularly preferred. ADOGEN 412™, a lauryl trimethyl ammonium chloride commercially available from Witco, is also preferred. Even more highly preferred are the lauryl trimethyl ammonium chloride and myristyl trimethyl ammonium chloride.

Alkoxylated quaternary ammonium (AQA) surfactants useful in the present invention are of the general formula:

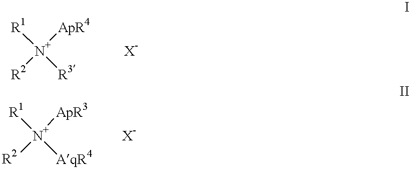

wherein R¹ is an alkyl or alkenyl moiety containing from about 8 to about 18 carbon atoms, preferably 10 to about 16 carbon atoms, most preferably from about 10 to about 14 carbon atoms; R² and R³ are each independently alkyl groups containing from one to about three carbon atoms, preferably methyl; R³ and R⁴ can vary independently and are selected from hydrogen (preferred), methyl and ethyl, X⁻ is an anion such as chloride, bromide, methylsulfate, sulfate, or the like, to provide electrical neutrality; A is selected from C₁-C₄ alkoxy, especially ethoxy (i.e., —CH₂CH₂O—), propoxy, butoxy and mixtures thereof; and for formula I, p is from 2 to about 30, preferably 2 to about 15, most preferably 2 to about 8; and for formula II, p is from 1 to about 30, preferably 1 to about 4 and q is from 1 to about 30, preferably 1 to about 4, and most preferably both p and q are 1.

Other quaternary surfactants include the ammonium surfactants such as alkyldimethylammonium halogenides, and those surfactants having the formula:

[R²(OR³)_{y}][R⁴(OR³)_{y}]₂R⁵N⁺X⁻

wherein R² is an alkyl or alkyl benzyl group having from about 8 to about 18 carbon atoms in the alkyl chain, each R³ is selected from the group consisting of —CH₂CH₂—, —CH₂CH(CH₃)—, —CH₂CH(CH₂OH)—, —CH₂CH₂CH₂—, and mixtures thereof; each R⁴ is selected from the group consisting of C₁-C₄ alkyl, C₁-C₄ hydroxyalkyl, benzyl, ring structures formed by joining the two R⁴ groups, —CH₂CHOHCHOHCOR⁶CHOH—CH₂OH wherein R⁶ is any hexose or hexose polymer having a molecular weight less than about 1000, and hydrogen when y is not O; R⁵ is the same as R⁴ or is an alkyl chain wherein the total number of carbon atoms of R² plus R⁵ is not more than about 18; each y is from 0 to about 10 and the sum of the y values is from 0 to about 15; and X is any compatible anion.

### vi. Fatty Acid

Suitable fatty acids that can be incorporated into the treating compositions of the present invention in addition to surfactants, include, but are not limited to, saturated and/or unsaturated fatty acids obtained from natural sources or synthetically prepared. Examples of fatty acids include capric, lauric, myristic, palmitic, stearic, arachidic, and behenic acid. Other fatty acids include palmitoleic, oleic, linoleic, linolenic, and ricinoleic acid.

### vii. Cationic/Amphoteric Surfactants

Non-quatemary, cationic surfactants can also be included in the treating compositions of the present invention. Cationic surfactants useful herein are described in U.S. Pat. No. 4,228,044, Cambre, issued Oct. 14, 1980.

Amphoteric surfactants can be incorporated into the treating compositions hereof. These surfactants can be broadly described as aliphatic derivatives of secondary or tertiary anines, or aliphatic derivatives of heterocyclic secondary and tertiary amines in which the aliphatic radical can be straight chain or branched. One of the aliphatic substituents contains at least about 8 carbon atoms, typically from about 8 to about 18 carbon atoms, and at least one contains an anionic water-solubilizing group, e.g., carboxy, sulfonate, sulfate. See U.S. Pat. No. 3,929,678 to Laughlin et al., issued Dec. 30, 1975 at column 19, lines 18-35 for examples of amphoteric surfactants. Preferred amphoteric include C₁₂-C₁₈ alkyl ethoxylates (“AE”) including the so-called narrow peaked alkyl ethoxylates and C₆-C₁₂ alkyl phenol alkoxylates (especially ethoxylates and mixed ethoxy/propoxy), C₁₂-C₁₈ betaines and sulfobetaines (“sultaines”), C₁₀-C₁₈ amine oxides, and mixtures thereof.

The amphoteric surfactants useful in the present invention are preferably selected from amine oxides including but not limited to water-soluble amine oxides containing one alkyl moiety of from about 10 to about 18 carbon atoms and 2 moieties selected from the group consisting of alkyl groups and hydroxyalkyl groups containing from about 1 to about 3 carbon atoms; water-soluble phosphine oxides containing one alkyl moiety of from about 10 to about 18 carbon atoms and 2 moieties selected from the group consisting of alkyl groups and hydroxyalkyl groups containing from about 1 to about 3 carbon atoms; and water-soluble sulfoxides containing one alkyl moiety of from about 10 to about 18 carbon atoms and a moiety selected from the group consisting of alkyl and hydroxyalkyl moieties of from about 1 to about 3 carbon atoms.

Other suitable, non-limiting examples of amphoteric detergent surfactants that are useful in the present invention include amido propyl betaines and derivatives of aliphatic or heterocyclic secondary and ternary amines in which the aliphatic moiety can be straight chain or branched and wherein one of the aliphatic substituents contains from about 8 to about 24 carbon atoms and at least one aliphatic substituent contains an anionic water-solubilizing group.

Further examples of suitable amphoteric surfactants are given in “Surface Active Agents and Detergents” (Vol. I and II by Schwartz, Perry and Berch), hereby incorporated by reference.

Preferably the amphoteric surfactant is present in the composition in an effective amount, more preferably from about 0.1% to about 20%, even more preferably about 0.1% to about 15%, even more preferably still from about 0.5% to about 10%,by weight.

### viii. Polyhydroxy Fatty Acid Amide Surfactants

The treating compositions hereof may also contain polyhydroxy fatty acid amide surfactant. The polyhydroxy fatty acid amide surfactant component comprises compounds of the structural formula:

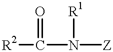

wherein: R¹ is H, C₁-C₄ hydrocarbyl, 2-hydroxy ethyl, 2-hydroxy propyl, or a mixture thereof, preferably C₁-C₄ alkyl, more preferably C ₁ or C₂ alkyl, most preferably C₁ alkyl (i.e., methyl); and R² is a C₅-C₃₁ hydrocarbyl, preferably straight chain C₇-C₁₉ alkyl or alkenyl, more preferably straight chain C₉-C₁₇ alkyl or alkenyl, most preferably straight chain C₁₁-C₁₅ alkyl or alkenyl, or mixtures thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z preferably will be derived from a reducing sugar in a reductive amination reaction; more preferably Z will be a glycityl. Suitable reducing sugars include glucose, fructose, maltose, lactose, galactose, mannose, and xylose. As raw materials, high dextrose corn syrup, high fructose corn syrup, and high maltose corn syrup can be utilized as well as the individual sugars listed above. These corn syrups may yield a mix of sugar components for Z. It should be understood that it is by no means intended to exclude other suitable raw materials. Z preferably will be selected from the group consisting of —CH₂—(CHOH)ₙ—CH₂OH, —CH(CH₂OH)—(CHOH)ₙ₋₁—CH₂OH, —CH₂—(CHOH)₂(CHOR′)(CHOH)—CH₂OH, and alkoxylated derivatives thereof, where n is an integer from 3 to 5, inclusive, and R′ is H or a cyclic or aliphatic monosaccharide. Most preferred are glycityls wherein n is 4, particularly —CH₂—(CHOH)₄—CH₂OH.

R′ can be, for example, N-methyl, N-ethyl, N-propyl, N-isopropyl, N-butyl, N-2-hydroxy ethyl, or N-2-hydroxy propyl.

R²—CO—N< can be, for example, cocamide, stearamide, oleamide, lauramide, myristamide, capricamide, palmitamide, tallowamide, etc.

Z can be 1-deoxyglucityl, 2-deoxyfructityl, 1-deoxymaltityl, 1-deoxylactityl, 1-deoxygalactityl, 1-deoxymannityl, 1-deoxymaltotriotityl, etc.

Methods for making polyhydroxy fatty acid amides are known in the art. In general, they can be made by reacting an alkyl amine with a reducing sugar in a reductive amination reaction to form a corresponding N-alkyl polyhydroxyamine, and then reacting the N-alkyl polyhydroxyamine with a fatty aliphatic ester or triglyceride in a condensation/amidation step to form the N-alkyl, N-polyhydroxy fatty acid amide product. Processes for making compositions containing polyhydroxy fatty acid amides are disclosed, for example, in G.B. Patent Specification 809,060, published Feb. 18, 1959, by Thomas Hedley & Co., Ltd., U.S. Pat. No. 2,965,576, issued Dec. 20, 1960 to E. R. Wilson, and U.S. Pat. No. 2,703,798, Anthony M. Schwartz, issued Mar. 8, 1955, and U.S. Pat. No. 1,985,424, issued Dec. 25, 1934 to Piggott, each of which is incorporated herein by reference.

### ix. Diamines

As noted above, the diamines used herein in detergent compositions in combination with detersive surfactants at levels which are effective for achieving at least a directional improvement in cleaning performance. In the context of a hand dishwashing composition, such “usage levels” can vary depending not only on the type and severity of the soils and stains, but also on the wash water temperature, the volume of wash water and the length of time the dishware is contacted with the wash water.

Since the habits and practices of the users of detergent compositions show considerable variation, the composition will preferably contain at least about 0.1%, more preferably at least about 0.2%, even more preferably, at least about 0.25%, even more preferably still, at least about 0.5% by weight of said composition of diamine. The composition will also preferably contain no more than about 15%, more preferably no more than about 10%, even more preferably, no more than about 6%, even more preferably, no more than about 5%, even more preferably still, no more than about 1.5% by weight of said composition of diamine.

In one of its several aspects, this invention provides a means for enhancing the removal of greasy/oily soils by combining the specific diamines of this invention with surfactants. Greasy/oily “everyday” soils are a mixture of triglycerides, lipids, complex polysaccharides, fatty acids, inorganic salts and proteinaceous matter.

Thus diamines, in combination with amphoteric and anionic surfactants in the specific ratios discussed below, offer the benefit of improved grease and tough food cleaning which allows the elimination or reduction in the amount of divalent ions in the preferred embodiments of the present formula. This improved cleaning is a result of diamines' proclivity as a buffering agent to increase the alkalinity of the dishwashing composition. The superior rate of dissolution achieved by divalent ion elimination even allows the formulator to make hand dishwashing detergents, especially compact formulations, at even significantly higher viscosities (e.g., 1,000 centipoise or higher) than conventional formulations while maintaining excellent dissolution and cleaning performance. This has significant potential advantages for making compact products with a higher viscosity while maintaining acceptable dissolution. By “compact” or “Ultra” is meant detergent formulations with reduced levels of water compared to conventional liquid detergents. For “compact” or “Ultra” formulations, the level of water is less than 50%, preferably less than 30% by weight of the liquid dishwashing detergent compositions. Said concentrated products provide advantages to the consumer, who has a product which can be used in lower amounts and to the producer, who has lower shipping costs. For compositions which are not meant to be concentrated, a suitable water level is less than about 85 %, more preferably less than about 70 % by weight of the liquid dishwashing detergent compositions.

It is preferred that the diamines used in the present invention are substantially free from impurities. That is, by “substantially free” it is meant that the diamines are over 95% pure, i.e., preferably 97%, more preferably 99%, still more preferably 99.5%, free of impurities. Examples of impurities which may be present in commercially supplied diamines include 2-Methyl-1,3-diaminobutane and alkylhydropyrimidine. Further, it is believed that the diamines should be free of oxidation reactants to avoid diamine degradation and ammonia formation.

As is discussed in greater detail below, making the compositions free of hydrogen peroxide is important when the compositions contain an enzyme. Even small amounts of hydrogen peroxide can cause problems with enzyme containing formulations. However, the diamine can react with any peroxide present and act as an enzyme stabilizer and prevent the hydrogen peroxide from reacting with the enzyme. The only draw back of this stabilization of the enzymes by the diamine is that the nitrogen compounds produced are believed to cause the malodors which can be present in diamine containing compositions. Having the diamine act as an enzyme stabilizer also prevents the diamine from providing the benefits to the composition for which it was originally put in to perform, namely, grease cleaning, sudsing, dissolution and low temperature stability. Therefore, it is preferred to minimize the amount of hydrogen peroxide present as an impurity in the inventive compositions either by using components which are substantially free of as an enzyme stabilizer, because of the possible generation of hydrogen peroxide and/or by using non-diamine antioxidants even though the diamine can act malodorous compounds and the reduction in the amount of diamine available present to perform its primary role.

Preferred organic diamines are those in which pK1 and pK2 are in the range of about 8.0 to about 11.5, preferably in the range of about 8.4 to about 11, even more preferably from about 8.6 to about 10.75. Preferred materials for performance and supply considerations are 1,3-bis(methylamine)-cyclohexane (pKa=10 to 10.5), 1,3 propane diamine (pK1=10.5; pK2=8.8), 1,6 hexane diamine (pK1=11; pK2=10), 1,3 pentane diamine (Dytek EP) (pK1=10.5; pK2=8.9), 2-methyl 1,5 pentane diamine (Dytek A) (pK1=11.2; pK2=10.0). Other preferred materials are the primary/primary diamines with alkylene spacers ranging from C4 to C8. In general, it is believed that primary diamines are preferred over secondary and tertiary diamines.

Definition of pK1 and pK2

As used herein, “pKa1” and “pKa2” are quantities of a type collectively known to those skilled in the art as “pKa” pKa is used herein in the same manner as is commonly known to people skilled in the art of chemistry. Values referenced herein can be obtained from literature, such as from “Critical Stability Constants: Volume 2, Amines” by Smith and Martel, Plenum Press, NY and London, 1975. Additional information on pKa's can be obtained from relevant company literature, such as information supplied by Dupont, a supplier of diamines.

As a working definition herein, the pKa of the diamines is specified in an all-aqueous solution at 25° C. and for an ionic strength between 0.1 to 0.5 M. The pKa is an equilibrium constant which can change with temperature and ionic strength; thus, values reported in the literature are sometimes not in agreement depending on the measurement method and conditions. To eliminate ambiguity, the relevant conditions and/or references used for pKa's of this invention are as defined herein or in “Critical Stability Constants: Volume 2, Amines”. One typical method of measurement is the potentiometric titration of the acid with sodium hydroxide and determination of the pKa by suitable methods as described and referenced in “The Chemist's Ready Reference Handbook” by Shugar and Dean, McGraw Hill, N.Y., 1990.

It has been determined that substituents and structural modifications that lower pK1 and pK2 to below about 8.0 are undesirable and cause losses in performance. This can include substitutions that lead to ethoxylated diamines, hydroxy ethyl substituted diamines, diamines with oxygen in the beta (and less so gamma) position to the nitrogen in the spacer group (e.g., Jeffamine EDR 148). In addition, materials based on ethylene diamine are unsuitable.

The diamines useful herein can be defined by the following structure:

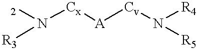

wherein R₂₋₅ are independently selected from H, methyl, —CH₃CH₂, and ethylene oxides; Cₓ, and Cᵥ, are independently selected from methylene groups or branched alkyl groups where x+y is from about 3 to about 6; and A is optionally present and is selected from electron donating or withdrawing moieties chosen to adjust the diamine pKa's to the desired range. If A is present, then x and y must both be 1 or greater. Examples of preferred diamines can be found in the copending provisional patent application of Phillip Kyle Vinson et al., entitled “Dishwashing Detergent Compositions Containing Organic Diamines for Improved Grease Cleaning, Sudsing, Low Temperature Stability and Dissolution”, having P & G Case No. 7167P, application serial no. 60/087,693, and filed on Jun. 2, 1998, which is hereby incorporated by reference.

### x. Secondary Surfactants

Secondary detersive surfactant can be selected from the group consisting of nonionics, cationics, amphoterics, zwitterionics, and mixtures thereof. By selecting the type and amount of detersive surfactant, along with other adjunct ingredients disclosed herein, the present detergent compositions can be formulated to be used in the context of laundry cleaning or in other different cleaning applications, particularly including dishwashing. The particular surfactants used can therefore vary widely depending upon the particular end-use envisioned. Suitable secondary surfactants are described in detail in the copending provisional patent application of Chandrika Kasturi et al., entitled “Liquid Detergent Compositions Comprising Polymeric Suds Enhancers”, having P & G Case No. 6938P, application serial no. 60/066,344, incorporated above.

### xi. Biodegradably Branched Surfactants

The treating compositions of the present invention may also include biodegradably branched and/or crystallinity disrupted and/or mid-chain branched surfactants or surfactant mixtures. The terms “biodegradably branched” and/or “crystallinity disrupted” and/or “mid-chain branched” (acronym “MCB” used hereinafter) indicate that such surfactants or surfactant mixtures are characterized by the presence of surfactant molecules having a moderately non-linear hydrophobe; more particularly, wherein the surfactant hydrophobe is not completely linear, on one hand, nor is it branched to an extent that would result in unacceptable biodegradation. The preferred biodegradably branched surfactants are distinct from the known commercial LAS, ABS, Exxal, Lial, etc. types, whether branched or unbranched. The biodegradably branched materials comprise particularly positioned light branching, for example from about one to about three methyl, and/or ethyl, and/or propyl or and/or butyl branches in the hydrophobe, wherein the branching is located remotely from the surfactant headgroup, preferably toward the middle of the hydrophobe. Typically from one to three such branches can be present on a single hydrophobe, preferably only one. Such biodegradably branched surfactants can have exclusively linear aliphatic hydrophobes, or the hydrophobes can include cycloaliphatic or aromatic substitution. Highly preferred are MCB analogs of common linear alkyl sulfate, linear alkyl poly(alkoxylate) and linear alkylbenzenesulfonate surfactants, said surfactant suitably being selected from mid-chain-C₁-C₄-branched C₈-C₁₈-alkyl sulfates, mid-chain-C₁-C₄-branched C₈-C₁₈-alkyl ethoxylated, propoxylated or butoxylated alcohols, mid-chain-C₁-C₄-branched C₈-C₁₈-alkyl ethoxysulfates, mid-chain-C₁-C₄-branched C₈-C₁₆-alkyl benzenesulfonates and mixtures thereof. When anionic, the surfactants can in general be in acid or salt, for example sodium, potassium, ammonium or substituted ammonium, form. The biodegradably branched surfactants offer substantial improvements in cleaning performance and/or usefulness in cold water and/or resistance to water hardness and/or economy of utilization. Such surfactants can, in general, belong to any known class of surfactants, e.g., anionic, nonionic, cationic, or zwitterionic. The biodegradably branched surfactants are synthesized through processes of Procter & Gamble, Shell, and Sasol. These surfactants are more fully disclosed in WO98/23712 A published Jun 4, 1998; WO97/38957 A published Oct. 23, 1997; WO97/38956 A published Oct. 23, 1997; WO97/39091 A published Oct. 23, 1997; WO97/39089 A published Oct. 23, 1997; WO97/39088 A published Oct. 23, 1997; WO97/39087 Al published Oct. 23, 1997; WO97/38972 A published Oct. 23, 1997; WO 98/23566 A Shell, published Jun. 4, 1998; technical bulletins of Sasol; and the following pending patent applications assigned to Procter & Gamble:

Preferred biodegradably branched surfactants herein in more detail include MCB surfactants as disclosed in the following references:

WO98/23712 A published Jun. 4, 1998 includes disclosure of MCB nonionic surfactants including MCB primary alkyl polyoxyalkylenes of formula (1): CH₃CH₂(CH₂)_{w}C(R¹)H(CH₂)ₓC(R′)H(CH₂)_{y}C(R²)H(CH₂) _{z}(EO/PO)ₘOH(1), where the total number of carbon atoms in the branched primary alkyl moiety of this formula, including the R, R¹ and R² branching, but not including the carbon atoms in the EO/PO alkoxy moiety, is preferably 14-20, and wherein further for this surfactant mixture, the average total number of carbon atoms in the MCB primary alkyl hydrophobe moiety is preferably 14.5-17.5, more preferably 15-17; R, R¹ and R² are each independently selected from hydrogen and 1-3C alkyl, preferably methyl, provided R, R¹ and R² are not all hydrogen and, when z is 1, at least R or R¹ is not hydrogen; w is an integer of 0-13; x is an integer of 0-13; y is an integer of 0-13; z is an integer of at least 1; w+x+y+z is 8-14; and EO/PO are alkoxy moieties preferably selected from ethoxy, propoxy and mixed ethoxy/propoxy groups, where m is at least 1, preferably 3-30, more preferably 5-20, most preferably 5-15. Such MCB nonionics can alternately include butylene oxide derived moieties, and the —OH moiety can be replaced by any of the well-known end-capping moieties used for conventional nonionic surfactants.

WO97/38957 A published Oct. 23, 1997 includes disclosure of mid- to near-mid-chain branched alcohols of formulae R—CH₂CH₂CH(Me)CH—R¹—CH₂OH (I) and HOCH₂—R—CH₂—CH₂—CH(Me)—R′ (II) comprising: (A) dimerising alpha-olefins of formula RCH═CH₂ and R¹CH═CH₂ to form olefins of formula R(CH₂)₂—C(R¹)═CH₂ and R¹(CH₂)₂—C(R)═CH₂; (B) (i) isomerising the olefins and then reacting them with carbon monoxide/hydrogen under Oxo conditions or (ii) directly reacting the olefins from step (A) with CO/H₂ under Oxo conditions. In the above formulae, R, R¹=3-7C linear alkyl. WO97/38957 A also discloses (i) production of MCB alkyl sulphate surfactants by sulphating (I) or (II); (ii) preparation of MCB alkylethoxy sulphates which comprises ethoxylating and then sulphating (I) or (II); (iii) preparation of MCB alkyl carboxylate surfactants which comprises oxidising (I) or (II) or their aldehyde intermediates and (iv) preparation of MCB acyl taurate, MCB acyl isethionate, MCB acyl sarcosinate or MCB acyl N-methylglucamide surfactants using the branched alkyl carboxylates as feedstock.

WO97/38956 A published Oct. 23, 1997 discloses the preparation of mid- to near mid-chain branched alpha olefins which is effected by: (a) preparing a mixture of carbon monoxide and hydrogen; (b) reacting this mixture in the presence of a catalyst under Fischer-Tropsch conditions to prepare a hydrocarbon mixture comprising the described olefins; and (c) separating the olefins from the hydrocarbon mixture. WO97/38956 A further discloses the preparation of mid- to near mid-chain branched alcohols by reacting the olefins described with CO/H₂ under Oxo conditions. These alcohols can be used to prepare (1) MCB sulphate surfactants by sulphating the alcohols; (2) MCB alkyl ethoxy sulphates by ethoxylating, then sulphating, the alcohols; or (3) branched alkyl carboxylate surfactants by oxidising the alcohols or their aldehyde intermediates. The branched carboxylates formed can be used as a feedstock to prepare branched acyl taurate, acyl isethionate, acyl sarcosinate or acyl N-methylglucamide surfactants, etc.

WO97/39091 A published Oct. 23, 1997 includes disclosure of a detergent surfactant composition comprising at least 0.5 ( especially 5, more especially 10, most especially 20) wt % of longer alkyl chain, MCB surfactant of formula (I). A-X-B (I) wherein A is a 9-22 (especially 12-18) C MCB alkyl hydrophobe having: (i) a longest linear C chain attached to the X-B moiety of 8-21C atoms; (ii) 1-3C alkyl moiety(s) branching from this longest linear chain; (iii) at least one of the branching alkyl moieties attached directly to a C of the longest linear C chain at a position within the range of position 2 C, counting from C 1 which is attached to the CH₂B moiety, to the omega-2 carbon (the terminal C minus 2C.); and (iv) the surfactant composition has an average total number of C atoms in the A-X moiety of 14.5-17.5 ( especially 15-17); and B is a hydrophilic (surfactant head-group) moiety preferably selected from sulfates, sulfonates, polyoxyalkylene ( especially polyoxyethylene or polyoxypropylene), alkoxylated sulphates, polyhydroxy moieties, phosphate esters, glycerol sulphonates, polygluconates, polyphosphate esters, phosphonates, sulphosuccinates, sulphosuccinates, polyalkoxylated carboxylates, glucamides, taurinates, sarcosinates, glycinates, isethionates, mono-/di-alkanol-amides, monoalkanolamide sulphates, diglycol-amide and their sulphates, glyceryl esters and their sulphates, glycerol ethers and their sulphates, polyglycerol ether and their sulphates, sorbitan esters, polyalkoxylated sorbitan esters, ammonio-alkane-sulphonates, amidopropyl betaines, alkylated quat., alkylated/poly-hydroxyalkylated (oxypropyl) quat., imidazolines, 2-yl succinates, sulphonated alkyl esters and sulphonated fatty acids; and X—is —CH₂— or —C(O)—. WO97/39091 A also discloses a laundry detergent or other cleaning composition comprising: (a) 0.001-99% of detergent surfactant (I); and (b) 1 -99.999% of adjunct ingredients.

WO97/39089 A published Oct. 23, 1997 includes disclosure of liquid cleaning compositions comprising: (a) as part of surfactant system 0.1-50 (especially 1-40) wt % of a mid-chain branched surfactant of formula (I); (b) as the other part of the surfactant system 0.1-50 wt % of co-surfactant(s); (c) 1-99.7 wt % of a solvent; and (d) 0.1-75 wt % of adjunct ingredients. Formula (I) is A—CH₂—B wherein A=9-22 (especially 12-18) C MCB alkyl hydrophobe having: (i) a longest linear C chain attached to the X-B moiety of 8-21C atoms; (ii) 1-3C alkyl moiety(s) branching from this longest linear chain; (iii) at least one of the branching alkyl moieties attached directly to a C of the longest linear C chain at a position within the range of position 2 C, counting from Carbon No. 1 which is attached to the CH₂B moiety, to the omega-2 carbon (the terminal C minus 2C); and (iv) the surfactant composition has an average total number of C atoms in the A-X moiety of 14.5-17.5 (especially 15-17); and B is a hydrophilic moiety selected from sulphates, polyoxyalkylene (especially polyoxyethylene and polyoxypropylene) and alkoxylated sulphates.

WO97/39088 A published Oct. 23, 1997 includes disclosure of a surfactant composition comprising 0.001-100% of MCB primary alkyl alkoxylated sulphate(s) of formula (I): CH₃CH₂(CH)_{w}CHR(CH₂)ₓCHR¹(CH₂)_{y}CHR²(CH₂)_{z}OSO₃M (I) wherein the total number of C atoms in compound (I) including R, R¹ and R², is preferably 14-20 and the total number of C atoms in the branched alkyl moieties preferably averages 14.5-17.5 (especially 15-17); R, R¹ and R² are selected from H and 1-3C alkyl ( especially Me) provided R, R¹ and R² are not all H; when z=1 at least R or R¹ is not H; M are cations especially selected from Na, K, Ca, Mg, quaternary alkyl ammonium of formula ^{N+R}³R⁴R⁵R⁶ (II); M is especially Na and/or K; R³, R⁴, R⁵, R⁶ are selected from H, 1-22C alkylene, 4-22C branched alkylene, 1-6C alkanol, 1-22C alkenylene, and/or 4-22C branched alkenylene; w, x, y=0-13; z is at least 1; w+x+y+z=8-14. WO97/39088 A also discloses (1) a surfactant composition comprising a mixture of branched primary alkyl sulphates of formula (I) as above. M is a water-soluble cation; When R² is 1-3C alkyl, the ratio of surfactants having z=1 to surfactants having z=2 or greater is preferably at least 1:1 ( most especially 1:100); (2) a detergent composition comprising: (a) 0.001-99% of MCB primary alkyl alkoxylated sulphate of formula (III) and/or (IV): CH₃(CH₂)ₐCH(CH₃)(CH₂)_{b}CH₂OSO₃M (III) CH₃(CH₂)_{d}CH(CH₃)(CH₂)ₑCH(CH₃)CH₂OSO₃M (IV) wherein a, b, d, and e are integers, preferably a+b−10-16, d+e=8-14 and when a+b=10, a=2-9 and b=1-8; when a+b−11, a=2-10 and b=1-9; when a+b=12, a=2-11 and b=1-10; when a+b=13, a=2-12 and b=1-11; when a+b=14, a=2-13 and b=1-12; when a+B=15, a=2-14 and b=1-13; when a+b=16, a=2-14 and b=1-14; when d+e=8, d=2-7 and e=1-6; when d+e=9, d=2-8and e=1-7;when d+e=10, d=2-9 and e=1-8; when d+e=11, d=2-10 and e=1-9; when d+e=12, d=2-11 and e=1-10; when d+e=13, d=2-12 and e=1-11; when d+e=14, d=2-13 and e=1-12; and (b) 1-99.99 wt % of detergent adjuncts; (3) a mid-chain branched primary alkyl sulphate surfactant of formula(V): CH₃CH₂(CH₂)ₓCHR¹(CH₂)_{y}CHR²(CH₂)_{z}OSO₃M (V) wherein x, y=0-12; z is at least 2; x+y+z=11-14; R¹ and R² are not both H; when one of R₁ or R² is H, and the other is Me, x +y +z is not 12 or 13; and when R¹ is H and R² is Me, x+y is not 11 ¹ when z=3 and x+y is not 9 when z=5; (4) Alkyl sulphates of formula (III) in which a and b are integers and a=b=12 or 13, a=2-11, b=1-10 ¹ and M is Na, K, and optionally substituted ammonium; (5) alkyl sulphates of formula (IV) in which d and e are integers and d=e is 10 or 11 and when d=e is 10, d=2-9 and e=1-8; when d=e=11, d=2-10and e=1-9 ¹ and m is Na, K, optionally substituted ammonium ( especially Na); (6) methyl branched primary alkyl sulphates selected from 3-, 4- 5-, 6-, 7-, 8-, 9-, 10-, 11-, 12- or 13- methyl pentadecanol sulphate; 3-, 4-, 5-, 6-, 7-, 8-, 9-, 10-, 11-, 12-, 13-, or 14- methyl hexadecanol sulphate; 2,3-, 2,4-, 2,5-, 2,6-, 2,7-, 2,8-, 2,9-, 2,10-, 2,11-, 2,12-methyl tetradecanol sulphate; 2,3-, 2,4-, 2,5-, 2,6-, 2,7-, 2,8-, 2,9-, 2,10-, 2,11-, 2,12-, or 2,13-methyl pentadecanol sulphate and/or mixtures of these compounds.

WO97/39087 A published Oct. 23, 1997 includes disclosure of a surfactant composition comprising 0.001-100% of mid-chain branched primary alkyl alkoxylated sulphate(s) of formula (I) wherein that total number of C atoms in compound (I) including R, R¹ and R³, but not including C atoms of EO/PO alkoxy moieties is 14-20 and the total number of C atoms in branched alkyl moieties averages 14.5-17.5 (especially 15-17); R, R1 and R2=H or 1-3C alkyl ( especially Me) and R, R¹ and R² are not all H; when z=1 at least R or R¹ is not H; M=cations especially selected from Na, K, Ca, Mg, quaternary alkyl amines of formnula (II) ( M is especially Na and/or K) R³, R⁴, R⁵, R⁶ =H, 1-22C alkylene, 4-22C branched alkylene, 1-6C alkanol, 1-22C alkenylene, and/or 4-22C branched alkenylene; w, x, y=0-13; z is at least 1; w+x+y+z=8-14; EO/PO are alkoxy moieties, especially ethoxy and/or propoxy; m is at least 0.01, especially 0.1-30, more especially 0.5-10, most especially 1-5. Also disclosed are: (1) a surfactant composition comprising a mixture of branched primary alkyl alkoxylated sulphates of formula (I) When R² =1-3C alkyl, the ratio of surfactants having z=2 or greater to surfactant having z=1 is at least 1:1, especially 1.5:1, more especially 3:1, most especially 4:1; (2) a detergent composition comprising: (a) 0.001-99% of mid-chain branched primary alkyl alkoxylated sulphate of formula (III) and/or (IV) M is as above; a, b, d, and e are integers, a+b=10-16, d+e=8-14 and when a+b=10, a=2-9 and b=1-8; when a+b=11, a=2-10 and b=1-9; when a+b=12, a=2-11 and b=1-10; when a+b=13, a=2-12 and b=1-11; when a+b=14, a=2-13 and b=1-12; when a+b=15, a=2-14 and b=1-13; when a+b=16, a=2-14 and b=1-14; when d+e=8, d=2-7 and e=1-6; when d+e=9, d=2-8 and e=1-7; when d+e=10, d=2-9 and e=1-8; when d+e=11, d=2-10 and e=1-9; when d+e=12, d=2-11 and e=1-10; when d+e=13, d=2-12 and e=111; when d+e=14, d=2-13 and e=1-12; and (b) 1-99.99 wt % of detergent adjuncts; (3) a MCB primary alkyl alkoxylated sulphate surfactant of formula(V) R1, R2, M, EO/PO, m as above; x,y=0-12; z is at least 2; x+y+z=11-14; (4) a mid-chain branched alkyl alkoxylated sulphate of formula (III) in which: a=2-11; b=1-10; a+b=12 or 13; M, EO/PO and m are as above; (5) a mid-chain branched alkyl alkoxylated sulphate compound of formula (IV) in which: d+e=10 or 11; when d+e=10, d=2-9 and e=1-8 and when d+e=11, d=2-10 and e=1-9; M is as above ( especially Na); EO/PO and m are as above; and (6) methyl branched primary alkyl ethoxylated sulphates selected from 3-, 4- 5-, 6-, 7-, 8-, 9-, 10-, 11-, 12- or 13-methyl pentadecanol ethoxylated sulphate; 3-, 4-, 5-, 6-, 7-, 8-, 9-, 10-, 11-, 12-, 13-, or 14-methyl hexadecanol ethoxylated sulphate; 2,3-, 2,4-, 2,5-, 2,6-, 2,7-, 2,8-, 2,9-, 2,10-, 2,11-, 2,12-methyl tetradecanol ethoxylated sulphate; 2,3-, 2,4-, 2,5-, 2,6-, 2,7-, 2,8-, 2,9-, 2,10-, 2,11-, 2,12-, or 2,13-methyl pentadecanol ethoxylated sulphate and/or mixtures of these compounds. The compounds are ethoxylated with average degree of ethoxylation of 0. 1-10.

WO97/38972 A published Oct. 23, 1997 includes disclosure of a method for manufacturing longer chain alkyl sulphate surfactant mixture compositions comprising (a) sulphating with SO₃, preferably in a falling film reactor, a long chain aliphatic alcohol mixture having an average carbon chain length of at least 14.5-17.5, the alcohol mixture comprising at least 10%, preferably at least 25%, more preferably at least 50% still more preferably at least 75%, most preferably at least 95% of a MCB aliphatic alcohol having formula (I); where: R, R¹, R² =H or 1-3C alkyl, preferably methyl, provided R, R¹ and R² are not all H, and when z=1, at least R or R¹ is not H; w,x,y=integers 0-13; z=integer of at least 1; and w+x+y+z=8-14; where the total number of carbon atoms in the branched primary, alkyl moiety of formula (I), including the R, R¹ and R² branching, is 14-20, and where further for the alcohol mixture the average total number of carbon atoms in the branched primary alkyl moieties having formula (I) is >14.5-17.5, preferably, >15-17; and (b) neutralising the alkyl sulphate acid produced by step (a), preferably using a base selected from KOH, NaOH, ammonia, monoethanolamine, triethanolamine and mixtures of these. Also disclosed is a method for manufacturing longer chain alkyl alkoxylated sulphate surfactant mixture compositions, comprising alkoxylating the specified long chain aliphatic alcohol mixture; sulphating the resulting polyoxyalkylene alcohol with SO₃; and neutralising the resulting alkyl alkoxylate sulphate acid. Alternatively, the alkyl alkoxylated sulphates may be produced directly from the polyoxyalkylene alcohol by sulphating with SO₃ and neutralising.

WO 98/23566 A Shell, published Jun. 4, 1998 discloses branched primary alcohol compositions having 8-36 C atoms and an average number of branches per mol of 0.7-3 and comprising ethyl and methyl branches. Also disclosed are: (1) a branched primary alkoxylate composition preparable by reacting a branched primary alcohol composition as above with an oxirane compound; (2) a branched primary alcohol sulphate preparable by sulphating a primary alcohol composition as above; (3) a branched alkoxylated primary alcohol sulphate preparable by alkoxylating and sulphating a branched alcohol composition as above; (4) a branched primary alcohol carboxylate preparable by oxidising a branched primary alcohol composition as above; (5) a detergent composition comprising: (a) surfactant(s) selected from branched primary alcohol alkoxylates as in (1), branched primary alcohol sulphates as in (2), and branched alkoxylated primary alcohol sulphates as in (3); (b) a builder; and (c) optionally additive(s) selected from foam control agents, enzymes, bleaching agents, bleach activators, optical brighteners, co-builders, hydrotropes and stabilisers. The primary alcohol composition, and the sulphates, alkoxylates, alkoxy sulphates and carboxylates prepared from them exhibit good cold water detergency and biodegradability.

Biodegradably branched surfactants useful herein also include the modified alkylaromatic, especially modified alkylbenzenesulfonate surfactants described in copending commonly assigned patent applications (P&G Case Nos. 7303P, 7304P). In more detail, these surfactants include (P&G Case 6766P) alkylarylsulfonate surfactant systems comprising from about 10% to about 100% by weight of said surfactant system of two or more crystallinity-disrupted alkylarylsulfonate surfactants of formula (B—Ar—D)ₐ(M^{q+})_{b} wherein D is SO₃_{⁻}, M is a cation or cation mixture, q is the valence of said cation, a and b are numbers selected such that said composition is electroneutral; Ar is selected from benzene, toluene, and combinations thereof; and B comprises the sum of at least one primary hydrocarbyl moiety containing from 5 to 20 carbon atoms and one or more crystallinity-disrupting moieties wherein said crystallinity-disrupting moieties interrupt or branch from said hydrocarbyl moiety; and wherein said alkylarylsulfonate surfactant system has crystallinity disruption to the extent that its Sodium Critical Solubility Temperature, as measured by the CST Test, is no more than about 40° C. and wherein further said alkylarylsulfonate surfactant system has at least one of the following properties: percentage biodegradation, as measured by the modified SCAS test, that exceeds tetrapropylene benzene sulfonate; and weight ratio of nonquatemary to quaternary carbon atoms in B of at least about 5:1.

Such compositions also include (P&G Case 7303P) surfactant mixtures comprising (preferably, consisting essentially of): (a) from about 60% to about 95% by weight (preferably from about 65% to about 90%, more preferably from about 70% to about 85%) of a mixture of branched alkylbenzenesulfonates having formula (I):

[chemical structure]

wherein L is an acyclic aliphatic moiety consisting of carbon and hydrogen and having two methyl termini, and wherein said mixture of branched alkylbenzenesulfonates contains two or more (preferably at least three, optionally more) of said compounds differing in molecular weight of the anion of said formula (I) and wherein said mixture of branched alkylbenzenesulfonates is characterized by an average carbon content of from about 10.0 to about 14.0 carbon atoms (preferably from about 11.0 to about 13.0, more preferably from about 11.5 to about 12.5), wherein said average carbon content is based on the sum of carbon atoms in R¹, L and R², (preferably said sum of carbon atoms in R¹, L and R² is from 9 to 15, more preferably, 10 to 14) and further, wherein L has no substituents other than A, R¹ and R²; M is a cation or cation mixture (preferably selected from H, Na, K, Ca, Mg and mixtures thereof, more preferably selected from H, Na, K and mixtures thereof, more preferably still, selected from H, Na, and mixtures thereof) having a valence q (typically from 1 to 2, preferably 1); a and b are integers selected such that said compounds are electroneutral (a is typically from 1 to 2, preferably 1, b is 1); R¹ is C₁-C₃ alkyl (preferably C₁-C₂ alkyl, more preferably methyl); R² is selected from H and C₁-C₃ alkyl (preferably H and C₁-C₂ alkyl, more preferably H and methyl, more preferably H and methyl provided that in at least about 0.5, more preferably 0.7, more preferably 0.9 to 1.0 mole fraction of said branched alkylbenzenesulfonates R² is H); A is a benzene moiety (typically A is the moiety —C₆H₄—, with the SO₃ moiety of Formula (I) in para-position to the L moiety, though in some proportion, usually no more than about 5%, preferably from 0 to 5% by weight, the SO₃ moiety is ortho- to L); and (b) from about 5% to about 60% by weight (preferably from about 10% to about 35%, more preferably from about 15% to about 30%) of a mixture of nonbranched alkylbenzenesulfonates having formula (II):

[chemical structure]

wherein a, b, M, A and q are as defined hereinbefore and Y is an unsubstituted linear aliphatic moiety consisting of carbon and hydrogen having two methyl termini, and wherein Y has an average carbon content of from about 10.0 to about 14.0 (preferably from about 11.0 to about 13.0, more preferably 11.5 to 12.5 carbon atoms); (preferably said mixture of nonbranched alkylbenzenesulfonates is further characterized by a sum of carbon atoms in Y, of from 9 to 15, more preferably 10 to 14); and wherein said composition is further characterized by a 2/3-phenyl index of from about 350 to about 10,000 (preferably from about 400 to about 1200, more preferably from about 500 to about 700) (and also preferably wherein said surfactant mixture has a 2-methyl-2-phenyl index of less than about 0.3, preferably less than about 0.2, more preferably less than about 0.1, more preferably still, from 0 to 0.05).

Also encompassed by way of mid-chain branched surfactants of the alkylbenzene-derived types are surfactant mixtures comprising the product of a process comprising the steps of: alkylating benzene with an alkylating mixture; sulfonating the product of (I); and neutralizing the product of (II); wherein said alkylating mixture comprises: (a) from about 1% to about 99.9%, by weight of branched C₇-C₂₀ monoolefins, said branched monoolefins having structures identical with those of the branched monoolefins formed by dehydrogenating branched parafins of formula R¹LR² wherein L is an acyclic aliphatic moiety consisting of carbon and hydrogen and containing two terminal methyls; R¹ is C₁ to C₃ alkyl; and R² is selected from H and C₁ to C₃ alkyl; and (b) from about 0.1% to about 85%, by weight of C₇-C₂₀ linear aliphatic olefins; wherein said alkylating mixture contains said branched C₇-C₂₀ monoolefins having at least two different carbon numbers in said C₇-C₂₀ range, and has a mean carbon content of from about 9.5 to about 14.5 carbon atoms; and wherein said components (a) and (b) are at a weight ratio of at least about 15:85.

### Ratio of Anionic to Amphoteric to Diamine

When anionic, amphoteric and diamine surfactants are present in the treating compositions of the present invention, the ratio of the anionic surfactant : amphoteric diamine is preferably from about 100:40:1 to about 9:0.5:1, by mole, more preferably from about 27:8:1 to about 11:3:1, by mole.

Further, when anionic and diamine surfactants are present in the treating compositions of the present invention, the mole ratio of anionic surfactant to diamine is preferably greater than 9:1, more preferably greater than 20:1.

### Other Detergent Ingredirnts

### Polymeric Suds Stabilizer

The compositions of the present invention may optionally contain a polymeric suds stabilizer. These polymeric suds stabilizers provide extended suds volume and suds duration without sacrificing the grease cutting ability of the liquid detergent compositions. These polymeric suds stabilizers are selected from:

i) homopolymers of (N,N-dialkylamino)alkyl acrylate esters having the formula:

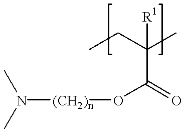

wherein each R is independently hydrogen, C₁-C₈ alkyl, and mixtures thereof, R¹ is hydrogen, C₁-C₆ alkyl, and mixtures thereof, n is from 2 to about 6; and

ii) copolymers of (i) and

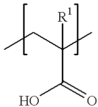

wherein R¹ is hydrogen, C₁-C6 alkyl, and mixtures thereof, provided that the ratio of (ii) to (i) is from about 2 to 1 to about 1 to 2; The molecular weight of the polymeric suds boosters, determined via conventional gel permeation chromatography, is from about 1,000 to about 2,000,000, preferably from about 5,000 to about 1,000,000, more preferably from about 10,000 to about 750,000, more preferably from about 20,000 to about 500,000, even more preferably from about 35,000 to about 200,000. The polymeric suds stabilizer can optionally be present in the form of a salt, either an inorganic or organic salt, for example the citrate, sulfate, or nitrate salt of (N,N-dimethylamino)alkyl acrylate ester.

One preferred polymeric suds stabilizer is (N,N-dimethylamino)alkyl acrylate esters, namely

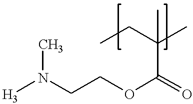

When present in the compositions, the polymeric suds booster may be present in the composition from about 0.01% to about 15%, preferably from about 0.05% to about 10%, more preferably from about 0.1% to about 5%, by weight.

### Builder

The compositions according to the present invention may further comprise a builder system. Because builders such as citric acid and citrates impair the stability of enzymes in LDL compositions, it is desirable to include reduce the amounts or completely remove the builder salts normally utilized in LDL compositions incorporating propylene glycol as a builder. When a detergent composition includes propylene glycol solvent as a part or a whole of the detergent's carrier, enzymes are more stable and smaller amounts or no builder salts are needed.

If it is desirable to use a builder, then any conventional builder system is suitable for use herein including aluminosilicate materials, silicates, polycarboxylates and fatty acids, materials such as ethylene-diamine tetraacetate, metal ion sequestrants such as aminopolyphosphonates, particularly ethylenediamine tetramethylene phosphonic acid and diethylene triamine pentamethylene-phosphonic acid. Though less preferred for obvious environmental reasons, phosphate builders can also be used herein.

Suitable polycarboxylates builders for use herein include citric acid, preferably in the form of a water-soluble salt, derivatives of succinic acid of the formula R—CH(COOH)CH₂(COOH) wherein R is C₁₀₋₂₀ alkyl or alkenyl, preferably C₁₂₋₁₆, or wherein R can be substituted with hydroxyl, sulfo sulfoxyl or sulfone substituents. Specific examples include lauryl succinate, myristyl succinate, palmityl succinate 2-dodecenylsuccinate, 2-tetradecenyl succinate. Succinate builders are preferably used in the form of their water-soluble salts, including sodium, potassium, ammonium and alkanolammonium salts.

Other suitable polycarboxylates are oxodisuccinates and mixtures of tartrate monosuccinic and tartrate disuccinic acid such as described in U.S. Pat. No. 4,663,071.

Especially for the liquid execution herein, suitable fatty acid builders for use herein are saturated or unsaturated C₁₀₋₁₈ fatty acids, as well as the corresponding soaps. Preferred saturated species have from 12 to 16 carbon atoms in the alkyl chain. The preferred unsaturated fatty acid is oleic acid. Other preferred builder system for liquid compositions is based on dodecenyl succinic acid and citric acid.

If detergency builder salts are included, they will be included in amounts of from 0.5 % to 50 % by weight of the composition preferably from 5% to 30% and most usually from 5% to 25% by weight.

### Enzymes

Detergent compositions of the present invention may further comprise one or more enzymes which provide cleaning performance benefits. Said enzymes include enzymes selected from cellulases, hemicellulases, peroxidases, proteases, glucoamylases, amylases, lipases, cutinases, pectinases, xylanases, reductases, oxidases, phenoloxidases, lipoxygenases, ligninases, pullulanases, tannases, pentosanases, malanases, B-glucanases, arabinosidases, mannanases, xyloglucanases, pectate lyases or mixtures thereof. A preferred combination is a detergent composition having a cocktail of conventional applicable enzymes like protease, amylase, lipase, cutinase and/or cellulase. Enzymes when present in the compositions, at from about 0.0001% to about 5% of active enzyme by weight of the detergent composition. Preferred proteolytic enzymes, then, are selected from the group consisting of Alcalase® (Novo Industri A/S), BPN′, Protease A and Protease B (Genencor), and mixtures thereof. Protease B is most preferred. Preferred amylase enzymes include TERMAMYL®, DURAMYL® and the amylase enzymes described in WO 94/18314 to Genencor International, WO 94/02597 to Novo, WO 95/26397 to Novo and WO 97/32961 to Procter & Gamble. Preferred mannanase enzymes are described in WO 99/09133, WO 99/09132, WO 99/09131, WO 99/09130, WO 99/09129, WO 99/09128, WO 99/09126 all to Procter & Gamble and WO 94/25576 to Novo. Preferred xyloglucanase enzymes are described in WO 98/38288, WO 97/23683, WO 99/02663 and WO 98/49387 all to Novo.

Further non-limiting examples of suitable and preferred enzymes are disclosed in the copending application: “Dishwashing Detergent Compositions Containing Organic Diamines for Improved Grease Cleaning, Sudsing, Low temperature stability and Dissolution”, having P & G Case No. 7167P and application Ser. No. 60/087,693, which is hereby incorporated by reference.

Because hydrogen peroxide and builders such as citric acid and citrates impair the stability of enzymes in LDL compositions, it is desirable to reduce or eliminate the levels of these compounds in compositions which contain enzymes. Hydrogen peroxide is often found as an impurity in surfactants and surfactant pastes. As such, the preferred level of hydrogen peroxide in the amine oxide or surfactant paste of amine oxide is 0-40 ppm, more preferably 0-15 ppm. Amine impurities in amine oxide and betaines, if present, should be minimized to the levels referred above for hydrogen peroxide.

### Magnesium Ions

While it is preferred that divalent ions be omitted from LDL compositions prepared according to the present invention, alternate embodiments of the present invention may include magnesium ions.

It is desirable to exclude all divalent ions from the present LDL compositions, because such ions may lead to slower dissolution as well as poor rinsing, and poor low temperature stability properties. Moreover, formulating such divalent ion-containing compositions in alkaline pH matrices may be difficult due to the incompatibility of the divalent ions, particularly magnesium, with hydroxide ions.

Nonetheless, the presence of magnesium ions offers several benefits. Notably, the inclusion of such divalent ions improves the cleaning of greasy soils for various LDL compositions, in particular compositions containing alkyl ethoxy carboxylates and/or polyhydroxy fatty acid amide. This is especially true when the compositions are used in softened water that contains few divalent ions.

But in the present invention, these benefits can be obtained without the inclusion of divalent ions. In particular, improved grease cleaning can be achieved without divalent ions by the inclusion of organic diamines in combination with amphoteric and anionic surfactants in the specific ratios discussed above while enzymes have been shown to improve the skin mildness performance of the present LDL compositions.

If they are to be included in an alternate embodiment of the present LDL compositions, then the magnesium ions are present at an active level of from about 0.01 % to 1 %, preferably from about 0.015 % to 0.5 %, more preferably from about 0.025 % to 0.1 %, by weight. The amount of magnesium ions present in compositions of the invention will be also dependent upon the amount of total surfactant present therein, including the amount of alkyl ethoxy carboxylates and polyhydroxy fatty acid amide.

Preferably, the magnesium ions are added as a hydroxide, chloride, acetate, sulfate, formate, oxide or nitrate salt to the compositions of the present invention. Because during storage, the stability of these compositions becomes poor due to the formation of hydroxide precipitates in the presence of compositions containing moderate concentrations of hydroxide ions, it may be necessary to add certain chelating agents. Suitable chelating agents are discussed further below and in U.S. Pat. No. 5,739,092, issued Apr. 14, 1998, to Ofosu-asante, incorporated herein by reference.

### Perfumes

Perfumes and perfumery ingredients useful in the present compositions and processes comprise a wide variety of natural and synthetic chemical ingredients, including, but not limited to, aldehydes, ketones, esters, and the like. Also included are various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients. Finished perfumes typically comprise from about 0.01% to about 2%, by weight, of the detergent compositions herein, and individual perfumery ingredients can comprise from about 0.0001% to about 90% of a finished perfume composition.

Non-limiting examples of perfume ingredients useful herein can be found in the copending provisional patent application: “Dishwashing Detergent Compositions Containing Organic Diamines for Improved Grease Cleaning, Sudsing, Low temperature stability and Dissolution”, having P & G Case No. 7167P, application Ser. No. 60/087,693, incorporated above.

### Chelating Agents

The detergent compositions herein may also optionally contain one or more iron and/or manganese chelating agents. Such chelating agents can be selected from the group consisting of amino carboxylates, amino phosphonates, polyfunctionally-substituted aromatic chelating agents and mixtures therein, all as hereinafter defined. Without intending to be bound by theory, it is believed that the benefit of these materials is due in part to their exceptional ability to remove iron and manganese ions from washing solutions by formation of soluble chelates.

Amino carboxylates useful as optional chelating agents include ethylenediaminetetrace-tates, N-hydroxyethylethylenediaminetriacetates, nitrilo-triacetates, ethylenediamine tetrapro-prionates, triethylenetetraaminehexacetates, diethylenetriaminepentaacetates, and ethanoldi-glycines, alkali metal, ammonium, and substituted ammonium salts therein and mixtures therein.

Amino phosphonates are also suitable for use as chelating agents in the compositions of the invention when at lease low levels of total phosphorus are permitted in detergent compositions, and include ethylenediaminetetrakis (methylenephosphonates) as DEQUEST. Preferred, these amino phosphonates to not contain alkyl or alkenyl groups with more than about 6 carbon atoms.

Polyfunctionally-substituted aromatic chelating agents are also useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelator for use herein is ethylenediamine disuccinate (“EDDS”), especially the [S,S] isomer as described in U.S. Pat. No. 4,704,233, Nov. 3, 1987, to Hartman and Perkins.

The compositions herein may also contain water-soluble methyl glycine diacetic acid (MGDA) salts (or acid form) as a chelant or co-builder. Similarly, the so called “weak” builders such as citrate can also be used as chelating agents.

If utilized, these chelating agents will generally comprise from about 0.1% to about 15% by weight of the detergent compositions herein. More preferably, if utilized, the chelating agents will comprise from about 0.1% to about 3.0% by weight of such compositions.

### Composition pH

Dishwashing compositions of the invention will be subjected to acidic stresses created by food soils when put to use, i.e., diluted and applied to soiled dishes. If a composition with a pH greater than 7 is to be more effective, it preferably should contain a buffering agent capable of providing a generally more alkaline pH in the composition and in dilute solutions. Dishwashing compositions of the present invention will thus contain from about 0.1% to 15%, preferably from about 1% to 10%, most preferably from about 2% to 8%, by weight, of a buffering agent. The pKa value of this buffering agent should be about 0.5 to 1.0 pH units below the desired pH value of the composition (determined as described above Preferably, the pKa of the buffering agent should be from about 7 to about 12. Under these conditions the buffering agent most effectively controls the pH while using the least amount thereof.

Preferred inorganic buffers/alkalinity sources include the alkali metal carbonates, alkali metal hydroxides and alkali metal phosphates, e.g., sodium carbonate, sodium hydroxide, sodium polyphosphate.

The buffering agent may be an active detergent in its own right, or it may be a low molecular weight, organic or inorganic material that is used in this composition solely for maintaining an alkaline pH. Preferred buffering agents for compositions of this invention are nitrogen-containing materials. Some examples are amino acids such as lysine or lower alcohol amines like mono-, di-, and tri-ethanolamine. The diamines, described in detail above, also act as buffering agents and are preferred buffering agents. Preferred buffering system for use in the present detergent compositions include a combination of 0.5 % diamine and 2.5 % citrate and a combination of 0.5 % diamine, 0.75 % potassium carbonate and 1.75 % sodium carbonate. Other preferred nitrogen-containing buffering agents are Tri(hydroxymethyl)amino methane (HOCH2)3CNH3 (TRIS), 2-amino-2-ethyl-1,3 -propanediol, 2-amino-2-methyl-propanol, 2-amino-2-methyl-1,3 -propanol, disodium glutamate, N-methyl diethanolamide, 1,3-diamino-propanol N,N′-tetra-methyl-1,3-diamino-2-propanol, N,N-bis(2-hydroxyethyl)glycine (bicine) and N-tris (hydroxymethyl)methyl glycine (tricine). Mixtures of any of the above are also acceptable. For additional buffers see McCutcheon's EMULSIFIERS AND DETERGENTS, North American Edition, 1997, McCutcheon Division, MC Publishing Company Kirk and WO 95/07971 both of which are incorporated herein by reference.

### Other Ingredients

The detergent compositions will further preferably comprise one or more detersive adjuncts selected from the following: soil release polymers, polymeric dispersants, polysaccharides, abrasives, bactericides and other antimicrobials, tarnish inhibitors, builders, enzymes, dyes, buffers, antifungal or mildew control agents, insect repellents, perfumes, hydrotropes, thickeners, processing aids, suds boosters, brighteners, anti-corrosive aids, stabilizers antioxidants and chelants. A wide variety of other ingredients useful in detergent compositions can be included in the compositions herein, including other active ingredients, carriers, hydrotropes, antioxidants, processing aids, dyes or pigments, solvents for liquid formulations, solid fillers for bar compositions, etc. If high sudsing is desired, suds boosters such as the C₁₀-C₁₆ alkanolamides can be incorporated into the compositions, typically at 1%-10% levels. The C₁₀-C₁₄ monoethanol and diethanol amides illustrate a typical class of such suds boosters. Use of such suds boosters with high sudsing adjunct surfactants such as the amine oxides, betaines and sultaines noted above is also advantageous.

An antioxidant can be optionally added to the detergent compositions of the present invention. They can be any conventional antioxidant used in detergent compositions, such as 2,6-di-tert-butyl-4-methylphenol (BHT), carbamate, ascorbate, thiosulfate, monoethanolamine(MEA), diethanolamine, triethanolamine, etc. It is preferred that the antioxidant, when present, be present in the composition from about 0.001% to about 5% by weight.

Various detersive ingredients employed in the present compositions optionally can be further stabilized by absorbing said ingredients onto a porous hydrophobic substrate, then coating said substrate with a hydrophobic coating. Preferably, the detersive ingredient is admixed with a surfactant before being absorbed into the porous substrate. In use, the detersive ingredient is released from the substrate into the aqueous washing liquor, where it performs its intended detersive function.

To illustrate this technique in more detail, a porous hydrophobic silica (trademark SIPERNAT D10, DeGussa) is admixed with a proteolytic enzyme solution containing 3%-5% of C₁₃₋₁₅ ethoxylated alcohol (EO 7) nonionic surfactant. Typically, the enzyme/surfactant solution is 2.5×the weight of silica. The resulting powder is dispersed with stirring in silicone oil (various silicone oil viscosities in the range of 500-12,500 can be used). The resulting silicone oil dispersion is emulsified or otherwise added to the final detergent matrix. By this means, ingredients such as the aforementioned enzymes, bleaches, bleach activators, bleach catalysts, photoactivators, dyes, fluorescers, fabric conditioners and hydrolyzable surfactants can be “protected” for use in detergents, including liquid laundry detergent compositions.

Further, these hand dishwashing detergent embodiments preferably further comprises a hydrotrope. Suitable hydrotropes include sodium, potassium, ammonium or water-soluble substituted ammonium salts of toluene sulfonic acid, naphthalene sulfonic acid, cumene sulfonic acid, xylene sulfonic acid.

### C. Pathogens

The substrates/articles used in accordance with the present invention contain pathogens. The pathogens may be any pathogen known to those skilled in the art. Preferably, the pathogens comprise pathogens that can be killed or rendered inactive by ozone. More preferably the pathogens are selected from the group consisting of viruses, bacteria, fungi (including molds), parasites and mixtures thereof. Even more preferably the pathogens comprise bacteria, preferably foodbome bacteria, more preferably foodbome bacteria selected from the group consisting of: Escherichia coli, Salmonella choleraesius, Listeria monocytogenes and mixtures thereof, most preferably the foodborne pathogens comprise Escherichia coli.

### D. Pathogen-containing Substrates/articles

The substrates/articles used in accordance with the present invention are include any substrate/article that comprises pathogens. Preferably the substrates/articles include hard and soft substrates/articles. Nonlimiting examples of hard substrates are selected from the group consisting of utensils, dishes, cookware, pots, pans, skillets, baby bottles, baby nipples, glassware, dentures, and mixtures thereof. Nonlimiting examples of soft substrates are selected from the group consisting of: sponges, wash cloths, scouring pads, brushes, gloves, reusable wipes and mixtures thereof. Some of the substrates are kitchen-related articles, while others are general cleaning-related articles for use throughout a house, restaurant, etc.

Preferably the substrates are soft substrates, more preferably the substrates are selected from the group consisting of sponges, wash cloths, gloves, reusable wipes and mixtures thereof; most preferably the substrates are sponges.

### Methods of the Present Invention

A method for pathogen-reducing a pathogen-containing substrate/article comprising contacting the substrate/article with a pathogen-reducing system comprising ozone such that the pathogen-reducing system kills and/or renders inactive the pathogen better than ozone alone kills and/or renders inactive the pathogen is provided by the present invention.

Preferably, the ozone is introduced as a gas from an ozone generator.

Preferably, the pathogen-reducing system further comprises a housing, preferably a sealed housing, in which the ozone is contained. Preferably, the pathogen-reducing system further comprises an ozone-enhancing agent, preferably a cleaning/detergent ingredient, more preferably a surfactant, most preferably a light-duty liquid detergent composition.

An additional embodiment of the present invention is a method for pathogen-reducing a substrate/article comprising two or more genera of pathogens, wherein the method comprises contacting the substrate/article with a pathogen-reducing system comprising ozone such that the pathogen-reducing system kills and/or renders inactive at least one of the two or more genera of pathogens better than ozone alone kills and/or renders inactive the same at least one of the two or more genera of pathogens.

A further embodiment of the present invention is a method for pathogen-reducing a pathogen and ozone-enhancing agent-containing substrate/article comprising contacting the substrate/article with ozone such that the combination of the ozone and ozone-enhancing agent kills and/or renders inactive the pathogen better than ozone alone kills and/or renders inactive the pathogen.

Still a further embodiment of the present invention is a method for pathogen-reducing a pathogen-containing substrate/article comprising:

a) contacting the pathogen-containing substrate/article with an ozone-enhancing agent, preferably in the presence of ozone; and

b) contacting the pathogen-containing substrate/article with ozone in a gaseous form.

wherein step a) precedes step b) or step b) precedes step a) or step a) and step b) occur concurrently, preferably wherein the ozone-enhancing agent and ozone are present on the substrate/article at the same time.

Under use conditions, the step of contacting the pathogen-containing substrate/article with an ozone-enhancing agent is usually completed with a diluted solution of the ozone-enhancing agent. For example, after a consumer completes hand washing the dishes, the sponge and/or wash cloth or other substrate/article in accordance with the present invention that the consumer was using will have a diluted solution of the ozone-enhancing agent on or in it as a result of the wash water. Most typical light duty liquid (LDL) dishwashing compositions, such as Dawn® commercially available from Procter & Gamble Company, is diluted during use to about 1 part LDL to 100 parts water. Those of ordinary skill in the art

Wherein the method further optionally, but preferably comprises enclosing the pathogen-containing substrate/article in a housing, wherein the enclosing step occurs prior to steps a) and b) or wherein the enclosing step occurs after step a) but prior to step b) or wherein the enclosing step occurs after step b) but prior to step a), preferably wherein the enclosing step occurs prior to steps a) and b) or after step a) but prior to step b), more preferably wherein the enclosing step occurs after step a) but prior to step b).

### Pathogen-reduced Substrate/article

A pathogen-reduced substrate/article results the methods of the present invention.

### Pathogen-reducing Composition

A pathogen-reducing composition comprising an ozone-enhancing agent such that when the pathogen-reducing composition comes into contact with pathogens in the presence of ozone, the combination of the pathogen-reducing composition and ozone kills and/or renders inactive the pathogens better than ozone alone kills and/or renders inactive the pathogens is provided by the present invention.

Preferably, the ozone-enhancing agent comprises a cleaning/detergent ingredient, more preferably a surfactant, even more preferably a surfactant selected from the group consisting of: anionic, nonionic, zwitterionic, cationic and amphoteric surfactants and mixtures thereof. Alternatively, the surfactant is selected from the group consisting of: alkyl alkoxy sulfates, amine oxides, alkanoyl glucoseamides, alkyl ethoxylates and mixtures thereof, more preferably from the group consisting of: alkyl alkoxy sulfates, amine oxides, alkyl ethoxylates and mixtures thereof.

In another embodiment of the present invention, the cleaning/detergent ingredient comprises a perfume.

The pathogen-reducing composition is preferably a light-duty liquid detergent composition.

The compositions and levels of materials herein are discussed with reference to neat product, such as a light duty liquid detergent composition comprising an ozone-enhancing agent. However, those skilled in the art appreciate that the neat product is typically diluted by the consumer during use. For example, most light-duty liquid detergent compositions are diluted 1:100 with water. Accordingly, under typical use conditions the sponge, wash cloth or other substrate/article will have about 0.5% to about 10%, more typically about 1% to about 5% by weight of LDL product remaining on it after the consumer completes washing of the dishes, etc.

### Product/instructions of Use

This invention also may encompass the inclusion of instructions on the use of the pathogen-reducing systems and/or pathogen-reducing compositions described herein with the packages containing the pathogen-reducing systems and/or pathogen-reducing compositions or with other forms of advertising associated with the sale or use of the pathogen-reducing systems and/or pathogen-reducing compositions. The instructions may be included in any manner typically used by consumer product manufacturing or supply companies. Examples include providing instructions on a label attached to the container holding the system and/or composition; on a sheet either attached to the container or accompanying it when purchased; or in advertisements, demonstrations, and/or other written or oral instructions which may be connected to the purchase or use of the pathogen-reducing systems and/or pathogen-reducing compositions.

Specifically the instructions will include a description of the use of the pathogen-reducing system and/or pathogen-reducing composition. The instructions, for instance, may additionally include information relating to the recommended amount of pathogen-reducing composition to apply to the pathogen-containing substrate/article, if soaking or rubbing is appropriate to the substrate/article; the recommended amount of water, if any, to apply to the substrate/article before and after treatment; other recommended treatment.

The pathogen-reducing system and/or pathogen-reducing composition may be incorporated into a product, the product may be a kit comprising the pathogen-reducing system and/or pathogen-reducing composition and preferably a housing and an ozone generator. Accordingly, a product comprising a pathogen-reducing system and/or pathogen-reducing composition of the present invention, the product further including instructions for using the pathogen-reducing system and/or pathogen-reducing composition to kill and/or render inactive pathogens on and/or in a pathogen-containing substrate/article.

The following examples are illustrative of the present invention, but are not meant to limit or otherwise define its scope. All parts, percentages and ratios used herein are expressed as percent weight unless otherwise specified.

### EXAMPLES

TABLE I
Liqht Duty Liquid dishwashing detergents
of the present invention are as follows:

| | Example 1 | Example 2 |
|---|---|---|
| | (Neat) | (Usage) |
| AE0.6S¹ | 26.1 | 0.261 |
| Amine oxide² | 6.5 | 0.065 |
| Citric acid | 2.6 | 0.026 |
| Suds boosting | 0.2 | 0.002 |
| polymer³ | | |
| Sodium | 3.50 | 0.0350 |
| Cumene | | |
| Sulfonate | | |
| propylene | 9.8 | 0.098 |
| glycol | | |
| Nonionic⁴ | 3.0 | 0.030 |
| Diamine⁵ | 0.50 | 0.0050 |
| Water | BAL. | BAL |
| Total Active | 36% | |
| Viscosity (cps | 780 | |
| @ 20° C.) | | |
| pH @ 10% | 9.0 | |

¹C12-13 alkyl ethoxy sulfonate containing an average of 0.6 ethoxy groups.
²C12-C14 Amine oxide.
³Polymer is (N,N-dimethylamino)ethyl methacrylate homopolymer
⁴Nonionic may be either C11 Alkyl ethoxylated surfactant containing 9 ethoxy groups or C10 Alkyl ethoxylated surfactant containing 8 ethoxy groups..
⁵1,3 bis(methylamine)-cyclohexane.

TABLE II
Liqht Duty Liquid dishwashing detergents of the
present invention are as follows:

| | Example | Example | Example | Example | Example | Example |
|---|---|---|---|---|---|---|
| | 3 | 4 | 5 | 6 | 7 | 8 |
| | (Neat) | (Usage) | (Neat) | (Neat) | (Usage) | (Usage) |
| AE0.6S¹ | 26.1 | 0.261 | 26.1 | 13.05 | 0.261 | 0.1305 |
| Amine oxide² | 6.5 | 0.065 | 6.5 | 3.25 | 0.055 | 0.0325 |
| Nonionic³ | 3 | 0.03 | 3 | 1.5 | 0.03 | 0.015 |
| Suds boosting | 0.2 | 0.002 | 0.2 | 0.1 | 0.002 | 0.001 |
| polymer⁴ | | | | | | |
| Diamine⁵ | 0.5 | 0.005 | 0.5 | 0.25 | 0.005 | 0.0025 |
| Sodium | 3.5 | 0.035 | 3.5 | 1.75 | 0.020 | 0.0175 |
| cumene | | | | | | |
| sulphonate | | | | | | |
| sodium | — | 0.005 | 0.5 | 0.25 | 0.006 | 0.0025 |
| chloride | | | | | | |
| propylene | 9.8 | — | 10.0 | 5.0 | — | 0.050 |
| glycol | | | | | | |
| polypropylene | — | 0.010 | 1.0 | 0.5 | 0.010 | 0.005 |
| glycol | | | | | | |
| Citrate | 2.6 | — | — | — | — | — |
| Mg²⁺ | — | — | — | — | 0.0004 | — |
| | — | — | 0.015 | 0.0075 | — | 0.000075 |
| Protease⁶ | | | | | | |
| Ethanol | — | 0.070 | 0.0 | 0.0 | 0.070 | 0.0 |
| Mole ratio | 23:8:1 | 23:8:1 | 23:8:1 | 23:8:1 | 23:8:1 | 23:8:1 |
| anionic: amine | | | | | | |
| oxide: diamine | | | | | | |
| pH @ 10% | 9 | 9 | 9 | 9 | 9 | 9 |

¹C12-13 alkyl ethoxy sulfonate containing an average of 0.6 ethoxy groups.
²C12-C14 Amine oxide.
³Nonionic may be either C11 Alkyl ethoxylated surfactant containing 9 ethoxy groups or C10 Alkyl ethoxylated surfactant containing 8 ethoxy groups.
⁴Polymer is (N,N-dimethylamino)ethyl methacrylate homopolymer
⁵1,3 bis(methylamine)-cyclohexane.
⁶The protease is selected from: Savinase ®; Maxatase ®; Maxacal ®; Maxapem 15 ®; subtilisin BPN and BPN′; Protease B; Protease A; Protease D; Primase ®; Durazym ®; Opticlean ®; and Optimase ®; and Alcalase ®.

TABLE III
Liqht Duty Liquid dishwashing detergents of
the present invention are as follows:

| | | | | Example |
|---|---|---|---|---|
| | Example 7 | Example 8 | Example 9 | 10 |
| AE0.6S¹ | 26.09 | 26.09 | 26.09 | 28.80 |
| Amine oxide² | 6.50 | 6.5 | 8.0 | 8.0 |
| Suds boosting | 0.20 | 0.20 | 0.20 | 0.22 |
| polymer³ | | | | |
| Sodium | 3.50 | 3.50 | 3.50 | 3.90 |
| Cumene | | | | |
| Sulfonate | | | | |
| Nonionic⁴ | 3.00 | 3.00 | 3.00 | 3.30 |
| Diamine⁵ | 0.50 | 0.50 | 0.50 | 0.55 |
| Sodium | 1.5 | 1.5 | 1.5 | 1.5 |
| Chloride | | | | |
| NaOH | 0.35 | 0.35 | 0.35 | 0.35 |
| Na₂CO₃ | 1.75 | 1.75 | 1.75 | 1.75 |
| K₂CO₃ | 0.75 | 0.75 | 0.75 | 0.75 |
| propylene | 4.0 | 4.0 | 4.0 | 4.0 |
| glycol | | | | |
| polypropylene | 1.0 | 1.0 | 1.0 | 1.0 |
| glycol | | | | |
| Ethanol | 3.0 | 0.7 | 0.7 | — |
| Water and Misc. | BAL. | BAL. | BAL. | BAL. |
| Viscosity (cps | 353 | 640 | 635 | 848 |
| @ 70F) | | | | |
| pH @ 10% | 10.8 | 10.8 | 10.80 | 10.8 |

¹C12-13 alkyl ethoxy sulfonate containing an average of 0.6 ethoxy groups.
²C12-C14 Amine oxide.
³Polymer is (N,N-dimethylamino)ethyl methacrylate homopolymer
⁴Nonionic may be either C11 Alkyl ethoxylated surfactant containing 9 ethoxy groups or C 10 Alkyl ethoxylated surfactant containing 8 ethoxy groups..
⁵1,3 bis(methylamine)-cyclohexane.

While particular embodiments of the subject invention have been described, it will be obvious to those skilled in the art that various changes and modifications of the subject invention can be made without departing from the spirit and scope of the invention. It is intended to cover, in the appended claims, all such modifications that are within the scope of the invention.

The compositions of the present invention can be suitably prepared by any process chosen by the formulator, non-limiting examples of which are described in U.S. Pat. No. 5,691,297 Nassano et al., issued Nov. 11, 1997; U.S. Pat. No. 5,574,005 Welch et al., issued Nov. 12, 1996; U.S. Pat. No. 5,569,645 Dinniwell et al., issued Oct. 29, 1996; U.S. Pat. No. 5,565,422 Del Greco et al., issued Oct. 15, 1996; U.S. Pat. No. 5,516,448 Capeci et al., issued May 14, 1996; U.S. Pat. No. 5,489,392 Capeci et al., issued Feb. 6, 1996; U.S. Pat. No. 5,486,303 Capeci et al., issued Jan. 23, 1996 all of which are incorporated herein by reference.

In addition to the above examples, the cleaning compositions of the present invention can be formulated into any suitable laundry detergent composition, non-limiting examples of which are described in U.S. Pat. No. 5,679,630 Baeck et al., issued Oct. 21, 1997; U.S. Pat. No. 5,565,145 Watson et al., issued Oct. 15, 1996; U.S. Pat. No. 5,478,489 Fredj et al., issued Dec. 26, 1995; U.S. Pat. No. 5,470,507 Fredj et al., issued Nov. 28, 1995; U.S. Pat. No. 5,466,802 Panandiker et al., issued Nov. 14, 1995; U.S. Pat. No. 5,460,752 Fredj et al., issued Oct. 24, 1995; U.S. Pat. No. 5,458,810 Fredj et al., issued Oct. 17, 1995; U.S. Pat. No. 5,458,809 Fredj et al., issued Oct. 17, 1995; U.S. Pat. No. 5,288,431 Huber et al., issued Feb. 22, 1994 all of which are incorporated herein by reference.

Having described the invention in detail with reference to preferred embodiments and the examples, it will be clear to those skilled in the art that various changes and modifications may be made without departing from the scope of the invention and the invention is not to be considered limited to what is described in the specification.

What is claimed is:

1. A pathogen-reducing system comprising ozone wherein the pathogen-reducing system kills and/or renders inactive pathogens better than ozone alone kills and/or renders inactive the pathogens.

2. The pathogen-reducing system according to claim 1 wherein the ozone is provided from an ozone generator.

3. The pathogen-reducing system according to claim 1 wherein the pathogens are in contact with a substrate.

4. The pathogen-reducing system according to claim 3 wherein the substrate comprises a hard substrate selected from the group consisting of: utensils, dishes, cookware, pots, pans, skillets, baby bottles, baby nipples, glassware, dentures and mixtures thereof.

5. The pathogen-reducing system according to claim 3 wherein the substrate comprises a soft substrate selected from the group consisting of: sponges, wash cloths, brushes, gloves, scouring pads, reusable wipes and mixtures thereof.

6. The pathogen-reducing system according to claim 5 wherein the soft substrate comprises a sponge or a wash cloth.

7. The pathogen-reducing system according to claim 1 wherein the pathogen-reducing system further comprises a housing in which the ozone is contained.

8. The pathogen-reducing system according to claim 1 wherein the pathogen-reducing system further comprises an ozone-enhancing agent.

9. The pathogen-reducing system according to claim 8 wherein the ozone-enhancing agent comprises a detergent ingredient.

10. The pathogen-reducing system according to claim 9 wherein the detergent ingredient comprises a surfactant.

11. The pathogen-reducing system according to claim 10 wherein the surfactant is selected from the group consisting of: anionic, nonionic, zwitterionic, cationic and amphoteric surfactants and mixtures thereof.

12. The pathogen-reducing system according to claim 10 wherein the surfactant is selected from the group consisting of: alkyl alkoxy sulfates, amine oxides, alkanoyl glucoseamides, alkyl ethoxylates and mixtures thereof.

13. The pathogen-reducing system according to claim 12 wherein the surfactant is selected from the group consisting of: alkyl alkoxy sulfates, amine oxides, alkyl ethoxylates and mixtures thereof.

14. The pathogen-reducing system according to claim 9 wherein the detergent ingredient comprises a perfume.

15. The pathogen-reducing system according to claim 1 wherein the pathogens are selected from the group consisting of viruses, bacteria, fungi, molds, parasites and mixtures thereof.

16. The pathogen-reducing system according to claim 15 wherein the pathogens comprise bacteria.

17. The pathogen-reducing system according to claim 16 wherein the pathogens comprise foodborne bacteria.

18. The pathogen-reducing system according to claim 17 wherein the foodborne bacteria are selected from the group consisting of: Escherichia coli, Salmonella choleraesius, Listeria monocytogenes and mixtures thereof.

19. The pathogen-reducing system according to claim 8 wherein the ozone-enhancing agent comprises a light-duty liquid detergent composition.

20. A pathogen-reducing system comprising:
a) ozone in a gaseous form; and
b) a substrate comprising a pathogen and an ozone-enhancing agent;
wherein the pathogen-reducing system kills and/or renders inactive the pathogen better than ozone alone kills and/or renders inactive the pathogens.

21. A pathogen-reducing system comprising:
a) ozone in a gaseous form;
b) an ozone-enhancing agent; and
c) a substrate comprising a pathogen;
wherein the ozone and the ozone-enhancing agent are distinct from one another and the substrate comes into contact with a) and b) in a sequential manner.

22. A pathogen-reducing system comprising:
a) ozone in a gaseous form; and
b) a substrate comprising two or more genera of pathogens and an ozone-enhancing agent;
wherein the pathogen-reducing system kills and/or renders inactive at least one of the two or more genera of pathogens better than ozone alone kills and/or renders inactive the at least one of the two or more genera of pathogens.

23. A pathogen-reducing system comprising:
a) ozone in a gaseous form; and
b) a substrate comprising one or more pathogens selected from the group consisting of: Escherichia coli, Salmonella choleraesius, Listeria monocytogenes and mixtures thereof; and an ozone-enhancing agent;
wherein the pathogen-reducing system kills and/or renders inactive at least one of the one or more pathogens better than ozone alone kills and/or renders inactive the at least one of the one or more pathogens.

24. A method for pathogen-reducing a pathogen-containing substrate comprising contacting the substrate with a pathogen-reducing system comprising ozone such that the pathogen-reducing system kills and/or renders inactive the pathogen better than ozone alone kills and/or renders inactive the pathogen.

25. The method according to claim 24 wherein the ozone is provided from an ozone generator.

26. The method according to claim 24 wherein the substrate comprises a hard substrate selected from the group consisting of: utensils, dishes, cookware, pots, pans, skillets, baby bottles, baby nipples, glassware, dentures and mixtures thereof.

27. The method according to claim 24 wherein the substrate comprises a soft substrate selected from the group consisting of: sponges, wash cloths, brushes, gloves, scouring pads, reusable wipes and mixtures thereof.

28. The method according to claim 27 wherein the soft substrate comprises a sponge or a wash cloth.

29. The method according to claim 24 wherein the pathogen-reducing system further comprises a housing in which the ozone is contained.

30. The method according to claim 24 wherein the pathogen-reducing system further comprises an ozone-enhancing agent.

31. The method according to claim 30 wherein the ozone-enhancing agent comprises a detergent ingredient.

32. The method according to claim 31 wherein the detergent ingredient comprises a surfactant.

33. The method according to claim 32 wherein the surfactant is selected from the group consisting of: anionic, nonionic, zwitterionic, cationic and amphoteric surfactants and mixtures thereof.

34. The method according to claim 32 wherein the surfactant is selected from the group consisting of: alkyl alkoxy sulfates, amine oxides, alkanoyl glucoseamides, alkyl ethoxylates and mixtures thereof.

35. The method according to claim 34 wherein the surfactant is s elected from the group consisting of: alkyl alkoxy sulfates, amine oxides, alkyl ethoxylates and mixtures thereof.

36. The method according to claim 31 wherein the detergent ingredient comprises a perfume.

37. The method according to claim 24 wherein the pathogens are selected from the group consisting of viruses, bacteria, fungi, molds, parasites and mixtures thereof.

38. The method according to claim 37 wherein the pathogens comprise bacteria.

39. The method according to claim 38 wherein the pathogens comprise foodbome bacteria.

40. The method according to claim 39 wherein the foodbome bacteria are selected from the group consisting of: Escherichia coli, Salmonella choleraesius, Listeria monocytogenes and mixtures thereof.

41. The method according to claim 30 wherein the ozone-enhancing agent comprises a light-duty liquid detergent composition.

42. A method for pathogen-reducing a pathogen-containing substrate comprising two or more genera of pathogens, wherein the method comprises contacting the substrate with a pathogen-reducing system comprising ozone such that the pathogen-reducing system kills and/or renders inactive at least one of the two or more genera of pathogens better than ozone alone kills and/or renders inactive the same at least one of the two or more genera of pathogens.

43. A method for pathogen-reducing a pathogen and ozone-enhancing agent-containing substrate comprising contacting the substrate with ozone such that the combination of the ozone and ozone-enhancing agent kills and/or renders inactive the pathogen better than ozone alone kills and/or renders inactive the pathogen.

44. A method for pathogen-reducing a pathogen-containing substrate comprising:
a) contacting the pathogen-containing substrate with an ozone-enhancing agent; and
b) contacting the pathogen-containing substrate with ozone in a gaseous form.

45. The method according to claim 44 wherein step a) precedes step b).

46. The method according to claim 44 wherein step b) precedes step a).

47. The method according to claim 46 wherein step a) occurs in the presence of ozone.

48. The method according to claim 44 wherein steps a) and b) occur concurrently.

49. The method according to claim 44 wherein the ozone-enhancing agent and ozone are present on or in the substrate at the same time.

50. The method according to claim 44 wherein the method further comprises enclosing the pathogen-containing substrate in a housing.

51. The method according to claim 50 wherein the enclosing step occurs prior to steps a) and b).

52. The method according to claim 50 wherein the enclosing step occurs after step a) but prior to step b).

53. The method according to claim 50 wherein the enclosing step occurs after step b) but prior to step a).

54. A sanitized substrate made by the method of claim 24.

55. A sanitized substrate made by the method of claim 42.

56. A sanitized substrate made by the method of claim 43.

57. A sanitized substrate made by the method of claim 44.

58. A pathogen-reducing composition comprising an ozone-enhancing agent such that when the pathogen-reducing composition comes into contact with pathogens in the presence of ozone, the combination of the pathogen-reducing composition and ozone kills and/or renders inactive the pathogens better than ozone alone kills and/or renders inactive the pathogens.

59. The pathogen-reducing composition according to claim 58 wherein the ozone-enhancing agent comprises a detergent ingredient.

60. The pathogen-reducing composition according to claim 59 wherein the detergent ingredient comprises a surfactant.

61. The pathogen-reducing composition according to claim 60 wherein the surfactant is selected from the group consisting of: anionic, nonionic, zwitterionic, cationic and amphoteric surfactants and mixtures thereof.

62. The pathogen-reducing composition according to claim 60 wherein the surfactant is selected from the group consisting of: alkyl alkoxy sulfates, amine oxides, alkanoyl glucoseamides, alkyl ethoxylates and mixtures thereof.

63. The pathogen-reducing composition according to claim 62 wherein the surfactant is selected from the group consisting of: alkyl alkoxy sulfates, amine oxides, alkyl ethoxylates and mixtures thereof.

64. The pathogen-reducing composition according to claim 59 wherein the detergent ingredient comprises a perfume.

65. The pathogen-reducing composition according to claim 58 wherein the pathogens are selected from the group consisting of viruses, bacteria, fungi, molds, parasites and mixtures thereof.

66. The pathogen-reducing composition according to claim 65 wherein the pathogens comprise bacteria.

67. The pathogen-reducing composition according to claim 66 wherein the pathogens comprise foodborne bacteria.

68. The pathogen-reducing composition according to claim 67 wherein the foodbome bacteria are selected from the group consisting of: Escherichia coli, Salmonella choleraesius, Listeria monocytogenes and mixtures thereof.

69. The pathogen-reducing system according to claim 59 wherein the ozone-enhancing agent comprises a light-duty liquid detergent composition.

70. A pathogen-reducing product comprising a pathogen-reducing system as claimed in claim 1, said product further including instructions for using said pathogen-reducing system to kill and/or render inactive pathogens on a substrate in need of treatment, the instructions including the step of contacting the substrate in need of treatment with the pathogen-reducing system such that said pathogen-reducing system treats said substrate.

71. A pathogen-reducing product comprising a pathogen-reducing composition as claimed in claim 58, said product further including instructions for using said pathogen-reducing composition in the presence of ozone to kill and/or render inactive pathogens on a substrate in need of treatment, the instructions including the step of contacting the substrate in need of treatment with the pathogen-reducing composition such that said pathogen-reducing composition treats said substrate.

72. The pathogen-reducing product according to claim 71 wherein said product is a light-duty liquid detergent composition.

73. The pathogen-reducing product according to claim 72 wherein said product further comprises a housing and an ozone generator.

74. A method for pathogen-reducing a pathogen-containing substrate comprising:
a) contacting the pathogen-containing substrate with an ozone-enhancing agent, wherein the ozone-enhancing agent is a 1% aqueous solution of a light duty liquid detergent composition; and
b) contacting the pathogen-containing substrate with ozone in a gaseous form.
